(19) United States
(12) Patent Application Publication
(10) Pub. No.: US 2026/0048584 A1
(43) Pub. Date: Feb. 19, 2026

(54) LIQUID EJECTING APPARATUS AND DRIVE METHOD OF LIQUID EJECTING APPARATUS

(71) Applicant: SEIKO EPSON CORPORATION, Tokyo (JP)

(72) Inventors: Yasuaki HAMADA, CHINO-SHI (JP); Yasuhiro ITAYAMA, KAI-SHI (JP)

(21) Appl. No.: 19/297,401

(22) Filed: Aug. 12, 2025

(30) Foreign Application Priority Data
Aug. 15, 2024 (JP) 2024-135615

(51) Int. Cl. B41J 2/045; B41J 2/14

(52) U.S. Cl. CPC B41J 2/04573; B41J 2/0455; B41J 2/0457; B41J 2/04588; B41J 2/14233; B41J 2/04581; B41J 2002/14491

(57) ABSTRACT

A liquid ejecting apparatus includes a liquid ejecting head that is provided with a plurality of piezoelectric elements that apply pressure to a liquid in a pressure chamber by being driven, an acquisition section that acquires a simultaneous drive number, which is the number of piezoelectric elements simultaneously driven among the plurality of piezoelectric elements, a determination section that determines a drive signal for driving the piezoelectric elements of the simultaneous drive number by adjusting a timing of changing a potential of the drive signal based on the simultaneous drive number, and a drive signal output section that outputs the drive signal determined by the determination section.

The present application is based on, and claims priority from JP Application Serial Number 2024-135615, filed Aug. 15, 2024, the disclosure of which is hereby incorporated by reference herein in its entirety.

### BACKGROUND

### 1. Technical Field

The present disclosure relates to a liquid ejecting apparatus and a drive method of a liquid ejecting apparatus.

### 2. Related Art

In the related art, a liquid ejecting apparatus that forms an image on a medium by ejecting a liquid such as ink onto the medium is known. For example, JP-A-2023-139519 discloses supplying a drive signal having a fluctuating potential to one or more piezoelectric elements among a plurality of piezoelectric elements.

After the potential of the drive signal supplied to the piezoelectric element fluctuates, it takes a certain period of time until the current is stabilized. By fluctuating the potential of the drive signal supplied to the piezoelectric element again after a timing at which the current is stabilized, the characteristics of the piezoelectric element can be sufficiently drawn out. However, the period during which the current after the potential of the drive signal fluctuates is stabilized may fluctuate, and the timing at which the current is stabilized is unknown. Therefore, in the above-described technique in the related art, since it is not known when it is the timing at which the current is stabilized, there is a problem that an appropriate drive signal cannot be supplied to the plurality of piezoelectric elements.

### SUMMARY

According to a preferred aspect of the present disclosure, there is provided a liquid ejecting apparatus including a liquid ejecting head that is provided with a plurality of piezoelectric elements that apply pressure to a liquid in a pressure chamber by being driven, an acquisition section that acquires a simultaneous drive number, which is the number of piezoelectric elements simultaneously driven among the plurality of piezoelectric elements, a determination section that determines a drive signal for driving the piezoelectric elements of the simultaneous drive number by adjusting a timing of changing a potential of the drive signal based on the simultaneous drive number, and a drive signal output section that outputs the drive signal determined by the determination section.

According to another preferred aspect of the present disclosure, there is provided a drive method of a liquid ejecting apparatus including a liquid ejecting head provided with a plurality of piezoelectric elements that apply pressure to a liquid in a pressure chamber by being driven, a drive signal output section that outputs a drive signal for driving one or more piezoelectric elements among the plurality of piezoelectric elements, and a control section that controls the liquid ejecting head and the drive signal output section, the method including causing the control section to acquire a simultaneous drive number, which is the number of piezoelectric elements simultaneously driven among the plurality of piezoelectric elements, and to cause the drive signal output section to output the drive signal in which a potential is changed at a timing adjusted based on the simultaneous drive number.

### BRIEF DESCRIPTION OF THE DRAWINGS

FIG. 1 is a functional block diagram illustrating an example of a configuration of a liquid ejecting apparatus.

FIG. 2 is a schematic diagram illustrating the liquid ejecting apparatus.

FIG. 3 is an exploded perspective view of a liquid ejecting head.

FIG. 4 is a cross-sectional view taken along line IV-IV in FIG. 3.

FIG. 5 is an enlarged cross-sectional view of a vicinity of a piezoelectric element.

FIG. 6 is a block diagram of a DA conversion circuit and a drive signal generation circuit.

FIG. 7 is a block diagram illustrating an example of a configuration of a switching circuit.

FIG. 8 is a diagram for describing a drive signal.

FIG. 9 is a diagram illustrating a change in voltage when the drive signal is supplied to the piezoelectric element.

FIG. 10 is a graph illustrating a measurement result of a current response when an ejection waveform is supplied to the piezoelectric element.

FIG. 11 is a graph illustrating a measurement result of a charge amount response when the ejection waveform is supplied to the piezoelectric element.

FIG. 12 is a graph illustrating a determination period for each of the integers of a simultaneous drive number from 1 to 10.

FIG. 13 is a graph illustrating a polarization amount for each of the integers of the simultaneous drive number from 1 to 10.

FIG. 14 is a graph illustrating a value of a current calculated by Expression (1) and Expression (2).

FIG. 15 is a graph illustrating a charge amount based on the current of FIG. 14.

FIG. 16 is a graph illustrating a length of a push inversion period based on a current calculated by Expression (1) and Expression (2).

FIG. 17 is a graph illustrating a polarization amount based on the current calculated by Expression (1) and Expression (2).

FIG. 18 is a diagram illustrating a flowchart illustrating a series of processes of a printing process.

FIG. 19 is a diagram illustrating a flowchart illustrating a series of processes of a drive signal adjustment process.

FIG. 20 is a diagram for describing a specific example of a process of a step SC 112.

FIG. 21 is a diagram for describing a specific example of the process of the step SC112 according to a second embodiment.

FIG. 22 is a graph illustrating a hysteresis curve illustrating a relationship between a voltage and a polarization of a piezoelectric body.

### DESCRIPTION OF EMBODIMENTS

Hereinafter, embodiments for carrying out the present disclosure will be described with reference to the drawings. However, in each drawing, the dimensions and scales of each part are appropriately different from the actual ones. In addition, since the embodiment described below is a suitable specific example of the present disclosure, various technically preferable limitations are added, and the scope of the present disclosure is not limited to these embodiments unless otherwise stated in the following description to particularly limit the present disclosure.

### A. First Embodiment

### A1. Overview of Liquid Ejecting Apparatus

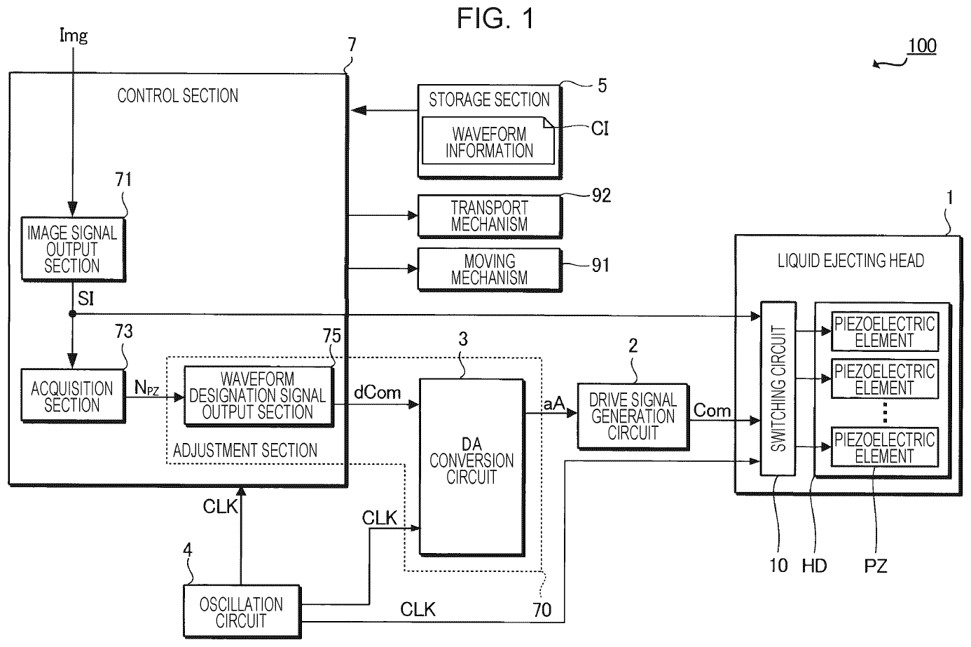

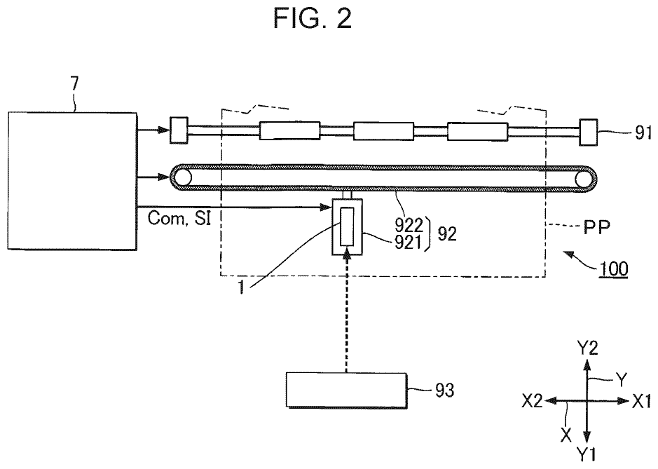

The configuration of a liquid ejecting apparatus 100 will be described with reference to FIGS. 1 and 2. FIG. 1 is a functional block diagram illustrating an example of the configuration of the liquid ejecting apparatus 100 according to the first embodiment. FIG. 2 is a schematic diagram illustrating the liquid ejecting apparatus 100. The liquid ejecting apparatus 100 is an ink jet printing apparatus that ejects an ink, which is an example of a liquid, to a medium PP. The medium PP is typically printing paper, but an optional printing target such as a resin film or fabric can be used as the medium PP.

As illustrated in FIG. 2, the liquid ejecting apparatus 100 includes a liquid container 93 that stores ink. As the liquid container 93, for example, a cartridge that can be attached to and detached from the liquid ejecting apparatus 100, a bag-shaped ink pack formed of a flexible film, an ink tank that can be replenished with ink, or the like can be employed. The liquid container 93 stores a plurality of types of ink with different colors.

As illustrated in FIG. 1, the liquid ejecting apparatus 100 includes a drive signal generation circuit 2, a DA conversion circuit 3, a liquid ejecting head 1, an oscillation circuit 4, a control section 7, a storage section 5, a moving mechanism 91, and a transport mechanism 92. As illustrated in FIGS. 1 and 2, the liquid ejecting apparatus 100 has the one liquid ejecting head 1, but may have the two or more liquid ejecting heads 1. A DAC is an abbreviation for a digital to analog converter. The drive signal generation circuit 2 is an example of a “drive signal output section”.

The oscillation circuit 4 generates a clock signal CLK used for timing in a plurality of circuits included in the liquid ejecting apparatus 100. The oscillation circuit 4 includes a crystal oscillator. The oscillation circuit 4 is, for example, a VCO that oscillates the clock signal CLK having a frequency according to a control voltage. The VCO is an abbreviation for a voltage controlled oscillator. The clock signal CLK is transmitted to, for example, the control section 7, the DA conversion circuit 3, and a switching circuit 10. Hereinafter, the reciprocal of the frequency of the clock signal CLK, that is, the cycle in which the clock signal CLK is supplied may be referred to as an adjustment cycle T_{CLK}. For simplification of the description, the clock signals CLK transmitted to the control section 7, the DA conversion circuit 3, and the switching circuit 10 have the same frequency, but may have different frequencies. For example, the oscillation circuit 4 may have one or both of a multiplication circuit that generates a frequency that is an integer multiple of the input frequency and a division circuit that generates a frequency that is 1/integer of the input frequency. As an example, the oscillation circuit 4 may output the clock signal generated by the VCO to the control section 7, and may output the clock signal of which frequency is changed by one or both of the multiplication circuit and the division circuit, to the DA conversion circuit 3 and the switching circuit 10. The clock signal CLK is an example of an “adjustment signal”. The oscillation circuit 4 is an example of an “adjustment signal output section”.

The control section 7 is, for example, a processing circuit such as a CPU or an FPGA. Here, the CPU is an abbreviation for a central processing unit, and the FPGA is an abbreviation for a field programmable gate array. The control section 7 controls each component of the liquid ejecting apparatus 100.

The storage section 5 is configured to include a volatile memory such as a RAM and a non-volatile memory such as a ROM, an EEPROM, or a PROM. The storage section 5 stores waveform information CI for generating a waveform designation signal dCom, printing data Img supplied from a host computer such as a personal computer or a digital camera, and various information such as a control program of the liquid ejecting apparatus 100. The RAM is an abbreviation for a random access memory. The ROM is an abbreviation for a read only memory. The EEPROM is an abbreviation for an electrically erasable programmable read-only memory. The PROM is an abbreviation for a programmable ROM.

The moving mechanism 91 transports the medium PP in a Y1 direction along a Y-axis under the control of the control section 7. Hereinafter, the Y1 direction and a Y2 direction opposite to the Y1 direction will be collectively referred to as a Y-axis direction. Additionally, hereinafter, an X1 direction along an X-axis that intersects the Y-axis and an X2 direction opposite to the X1 direction will be collectively referred to as an X-axis direction. Further, hereinafter, a Z1 direction along a Z-axis that intersects the X-axis and the Y-axis and a Z2 direction opposite to the Z1 direction will be collectively referred to as a Z-axis direction. In the present embodiment, for example, description will be made by assuming a case where the X-axis, the Y-axis, and the Z-axis are orthogonal to each other. However, the present disclosure is not limited to such an aspect. The X-axis, the Y-axis, and the Z-axis may intersect one another.

The transport mechanism 92 reciprocates the liquid ejecting head 1 in the X1 direction and the X2 direction under the control of the control section 7. As illustrated in FIG. 2, the transport mechanism 92 includes a storage case 921 that stores the liquid ejecting head 1, and an endless belt 922 to which the storage case 921 is fixed. The liquid container 93 may be stored in the storage case 921 together with the liquid ejecting head 1.

The liquid ejecting head 1 includes a recording head HD that includes M piezoelectric elements PZ for ejecting ink, and the switching circuit 10. In the present embodiment, M is an integer of 2 or greater.

The control section 7 controls the ejection operation of the liquid ejecting head 1. Specifically, the control section 7 generates an image signal SI for controlling the liquid ejecting head 1, the waveform designation signal dCom to be input to the DA conversion circuit 3, a signal for controlling the transport mechanism 92, and a signal for controlling the moving mechanism 91.

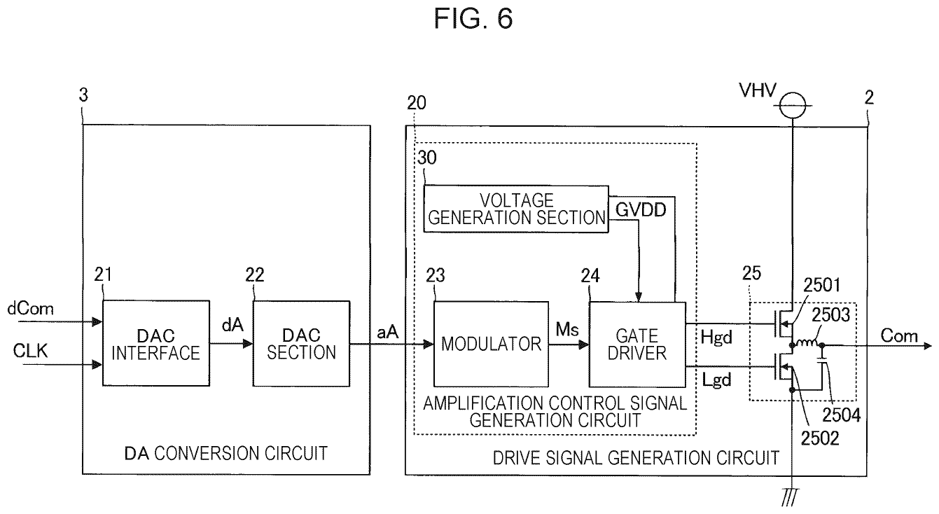

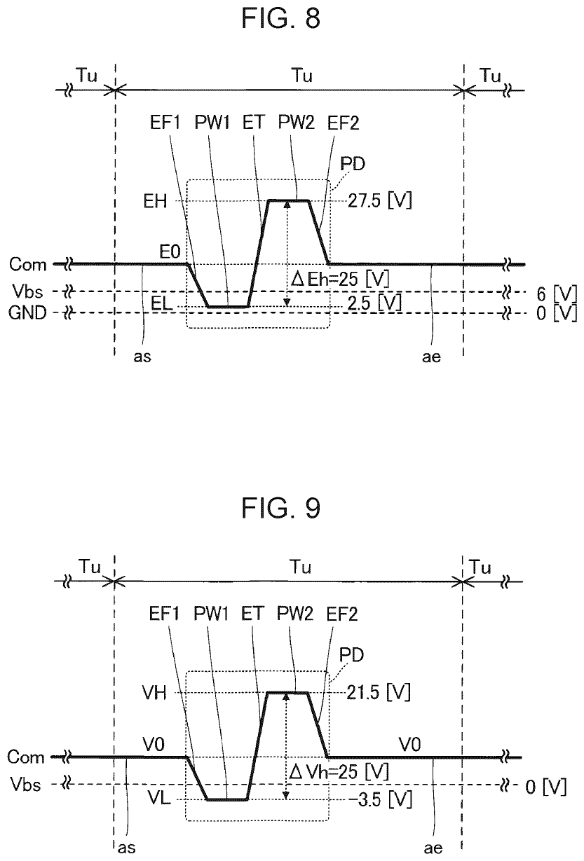

Here, the waveform designation signal dCom is a digital signal that defines a waveform of a drive signal Com. The control section 7 generates the waveform designation signal dCom based on the waveform information CI. Details of the waveform information CT will be described later with reference to FIG. 8. The drive signal Com is an analog signal for driving the piezoelectric element PZ. The DA conversion circuit 3 performs conversion to obtain a base drive signal aA, which is an analog signal, based on the clock signal CLK and the waveform designation signal dCom. The base drive signal aA is a target signal before amplification of the drive signal Com. The drive signal generation circuit 2 generates the drive signal Com based on the base drive signal aA. The configurations of the DA conversion circuit 3 and the drive signal generation circuit 2 will be described later with reference to FIG. 6.

The image signal SI is a digital signal for designating the type of operation of the piezoelectric element PZ. Specifically, the image signal SI designates the type of operation of the piezoelectric element PZ by designating whether or not to supply the drive signal Com to the piezoelectric element PZ.

First, the control section 7 stores the printing data Img supplied from the host computer in the storage section 5. Next, the control section 7 outputs the clock signal CLK and generates various control signals such as the image signal SI, the waveform designation signal dCom, a signal for controlling the transport mechanism 92, and a signal for controlling the moving mechanism 91 based on various data such as the printing data Img stored in the storage section 5. The control section 7 controls the liquid ejecting head 1 such that the piezoelectric element PZ is driven when the transport mechanism 92 and the moving mechanism 91 are controlled to change the relative position of the medium PP with respect to the liquid ejecting head 1 based on various control signals and various data stored in the storage section 5. As a result, the control section 7 adjusts the presence and absence of ink ejection, the ejection amount of ink, the ejection timing of ink, or the like, and controls the execution of the printing process of forming the image corresponding to the printing data Img on the medium PP.

The control section 7 reads the control program stored in the storage section 5 and executes the read control program to function as an image signal output section 71, an acquisition section 73, and a waveform designation signal output section 75. Further, the control section 7 that functions as the waveform designation signal output section 75 and the DA conversion circuit 3 function as a determination section 70 (hereinafter, also referred to as an adjustment section). The function of each section will be described later.

### A2. Configuration of Liquid Ejecting Head 1

The liquid ejecting head 1 will be described. In the following, in order to distinguish each of the M piezoelectric elements PZ provided in the liquid ejecting head 1, the piezoelectric elements PZ may be referred to as a first stage, a second stage, . . . , and an M-th stage. In addition, the m-th stage piezoelectric element PZ may be referred to as a piezoelectric element PZ[m]. In the following description, the variable m is an integer of 1 or greater and M or less. In addition, when a component, a signal, or the like of the liquid ejecting apparatus 100 corresponds to the ordinal number “m” of the piezoelectric element PZ[m], a suffix “[m]” that indicates the correspondence to the ordinal number “m” may be added to a symbol for representing the component, the signal, or the like.

The switching circuit 10 switches whether or not to supply the drive signal Com output from the drive signal generation circuit 2 to each of the piezoelectric elements PZ.

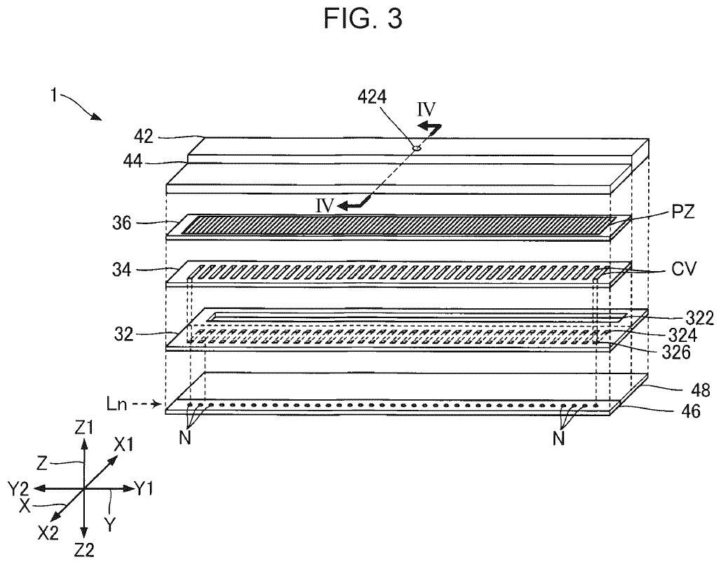

The liquid ejecting head 1 will be described with reference to FIGS. 3, 4, and 5.

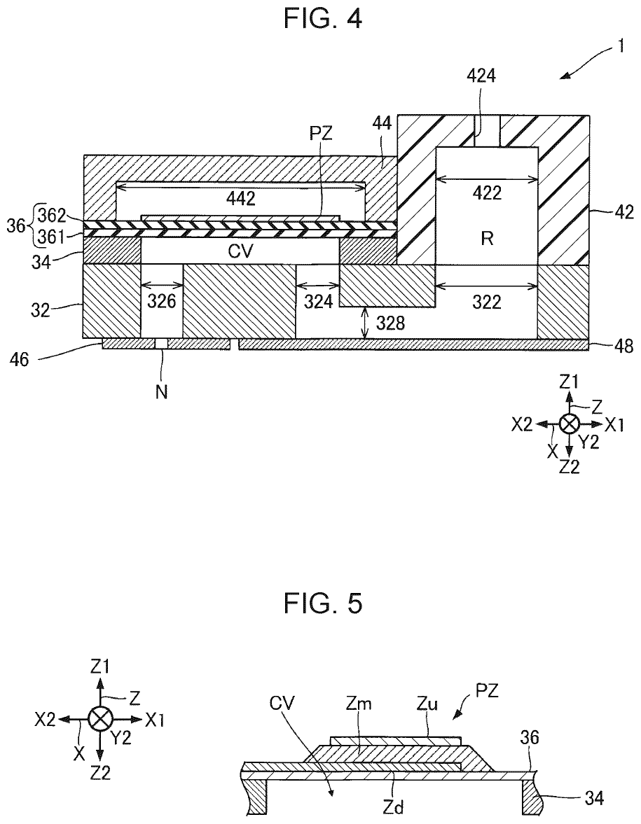

FIG. 3 is an exploded perspective view of the liquid ejecting head 1. FIG. 4 illustrates a cross-sectional view taken along line IV-IV illustrated in FIG. 3. The IV-IV cross section is parallel to the XZ plane and passes through an introduction port 424 described later. However, in FIGS. 3 and 4, the display of the switching circuit 10 is omitted.

As illustrated in FIGS. 3 and 4, the liquid ejecting head 1 includes a flow path substrate 32 having a substantially rectangular shape that is long along the Y-axis. A pressure chamber substrate 34, a diaphragm 36, the M piezoelectric elements PZ, a housing section 42, and a sealing member 44 are installed on the surface of the flow path substrate 32 in an upward direction. A nozzle plate 46 and a vibration absorber 48 are installed on the surface of the flow path substrate 32 in a downward direction. The respective elements of the liquid ejecting head 1 are schematically plate-shaped members that are long along the Y-axis, similar to the flow path substrate 32, and are joined to each other by using, for example, an adhesive. Although not illustrated, the switching circuit 10 is provided on, for example, the surface of the sealing member 44 in the Z1 direction.

As illustrated in FIG. 3, the nozzle plate 46 is a plate-shaped member in which M nozzles N arranged along the Y-axis are formed. The M nozzles N compose a nozzle column Ln. Each of the nozzles N is a through hole through which ink passes. The flow path substrate 32, the pressure chamber substrate 34, and the nozzle plate 46 are formed by processing, for example, a silicon single crystal substrate by a semiconductor manufacturing technology such as etching. However, the material and the manufacturing method of each element of the liquid ejecting head 1 are optional. The direction of the Y-axis may be referred to as the direction of the nozzle column Ln.

The flow path substrate 32 is a plate-shaped member for forming a flow path for ink. As illustrated in FIGS. 3 and 4, the flow path substrate 32 is formed with an opening section 322, a supply flow path 324, and a communication flow path 326. The opening section 322 is a through hole that is continuous over the M nozzles N along the Y-axis in plan view in the Z-axis direction. The supply flow path 324 and the communication flow path 326 are through holes individually formed for each of the nozzles N. In addition, as illustrated in FIG. 4, a relay flow path 328 extending over the M supply flow paths 324 is formed at the surface of the flow path substrate 32 in the Z2 direction. The relay flow path 328 is a flow path that allows the opening section 322 and the M supply flow paths 324 to communicate with each other.

The housing section 42 is a structure manufactured by, for example, injection molding of a resin material, and is fixed to the surface of the flow path substrate 32 in the upward direction. As illustrated in FIG. 4, the housing section 42 is formed with an accommodating section 422 and the introduction port 424. The accommodating section 422 is a recess portion having a shape corresponding to the opening section 322 of the flow path substrate 32. The introduction port 424 is a through hole that communicates with the accommodating section 422. As understood from FIG. 3, a space that allows the opening section 322 of the flow path substrate 32 and the accommodating section 422 of the housing section 42 to communicate with each other functions as a liquid storage chamber R. The ink supplied from the liquid container 93 and passing through the introduction port 424 is stored in the liquid storage chamber R.

As illustrated in FIGS. 3 and 4, the sealing member 44 is a structure that protects the M piezoelectric elements PZ from the outside and reinforces the mechanical strength of the pressure chamber substrate 34 and the diaphragm 36. The sealing member 44 is fixed to the surface of the diaphragm 36 with, for example, an adhesive. The sealing member 44 has a recess portion on the surface facing the diaphragm 36. The sealing member 44 is fixed to the surface of the diaphragm 36 to form a sealing space 442. The M piezoelectric elements PZ are provided in the sealing space 442.

The vibration absorber 48 absorbs the pressure fluctuation in the liquid storage chamber R. The vibration absorber 48 includes, for example, a flexible sheet member with the possibility of elastic deformation. Specifically, the vibration absorber 48 is installed on the surface of the flow path substrate 32 in the downward direction such that the bottom surface of the liquid storage chamber R is formed by closing the opening section 322 of the flow path substrate 32, the relay flow path 328, and a plurality of supply flow paths 324.

As illustrated in FIGS. 3 and 4, the pressure chamber substrate 34 is a plate-shaped member in which M pressure chambers CV respectively corresponding to the M nozzles N are formed. The M pressure chambers CV are arranged to be spaced apart from each other along the Y-axis. Each of the pressure chambers CV is an opening that is long along the X-axis. An end portion of the pressure chamber CV in the X1 direction overlaps the one supply flow path 324 in plan view, and an end portion of the pressure chamber CV in the X2 direction overlaps the one communication flow path 326 of the flow path substrate 32 in plan view.

The diaphragm 36 is installed on a surface of the pressure chamber substrate 34 in a direction opposite to a surface of the pressure chamber substrate 34, facing the flow path substrate 32. The diaphragm 36 is a plate-shaped member that is elastically deformable. As illustrated in FIG. 4, the diaphragm 36 of the first embodiment is configured by stacking an elastic film 361 and an insulating film 362. The insulating film 362 is positioned in a direction opposite to the pressure chamber substrate 34 when viewed from the elastic film 361. The elastic film 361 is formed of, for example, silicon oxide. The insulating film 362 is formed of, for example, zirconium oxide.

As can be understood from FIGS. 3 and 4, the flow path substrate 32 and the diaphragm 36 face each other at an interval inside each of the pressure chambers CV. The pressure chamber CV is positioned between the flow path substrate 32 and the diaphragm 36, and is a space for applying pressure to the ink filled in the pressure chamber CV. The diaphragm 36 forms a portion of the wall surface of the pressure chamber CV. The ink stored in the liquid storage chamber R branches from the relay flow path 328 to each of the supply flow paths 324, and is supplied to and filled into the M pressure chambers CV in parallel. That is, the liquid storage chamber R functions as a common liquid chamber for supplying the ink to the M pressure chambers CV.

As illustrated in FIGS. 3 and 4, the M piezoelectric elements PZ corresponding to each of the M nozzles N are installed on the surface of the diaphragm 36 in the direction opposite to the pressure chamber substrate 34. Each of the piezoelectric elements PZ is an actuator that is deformed by the supply of the drive signal Com, and is formed in a long shape along the X-axis. The M piezoelectric elements PZ are arranged along the Y-axis to correspond to the M pressure chambers CV. When the diaphragm 36 vibrates in conjunction with the deformation of the piezoelectric element PZ, the pressure in the pressure chamber CV fluctuates, so that the ink filled in the pressure chamber CV passes through the communication flow path 326 and the nozzle N and is ejected. That is, the piezoelectric element PZ is a drive element that ejects the ink in the pressure chamber CV from the nozzle N by vibrating the diaphragm 36.

FIG. 5 is an enlarged cross-sectional view illustrating the vicinity of the piezoelectric element PZ. However, in FIG. 5, the sealing member 44 is not illustrated to prevent the drawing from being complicated.

As illustrated in FIG. 5, the piezoelectric element PZ is a laminate in which a piezoelectric body Zm is interposed between an upper electrode Zu to which a predetermined reference potential Vbs is supplied and a lower electrode Zd to which the drive signal Com is supplied. The piezoelectric element PZ is, for example, a part in which the lower electrode Zd, the upper electrode Zu, and the piezoelectric body Zm overlap each other when viewed in the Z1 direction. Further, the pressure chamber CV is provided in the Z2 direction of a piezoelectric element PZ. In the first embodiment, there is an aspect in which the reference potential Vbs is supplied to the upper electrode Zu, and the drive signal Com is supplied to the lower electrode Zd, but there may be an aspect in which the drive signal Com is supplied to the upper electrode Zu, and the reference potential Vbs is supplied to the lower electrode Zd.

When a voltage is applied between the upper electrode Zu and the lower electrode Zd, the piezoelectric element PZ is displaced in the Z1 direction or the Z2 direction according to the applied voltage, and as a result of the displacement, the piezoelectric element PZ vibrates.

### A3. Configuration of DA Conversion Circuit 3 and Drive Signal Generation Circuit 2

FIG. 6 is a block diagram of the DA conversion circuit 3 and the drive signal generation circuit 2. The DA conversion circuit 3 includes a DAC interface 21 and a DAC section 22. The drive signal generation circuit 2 includes an amplification control signal generation circuit 20 and a drive signal output circuit 25. The amplification control signal generation circuit 20 generates amplification control signals Hgd and Lgd based on the base drive signal aA. The amplification control signal generation circuit 20 includes a modulator 23 and a gate driver 24. In the present embodiment, the DA conversion circuit 3 and the drive signal generation circuit 2 may be separate circuits or an integrated circuit.

The waveform designation signal dCom supplied from the control section 7 and the clock signal CLK output from the control section 7 are input to the DAC interface 21. The DAC interface 21 generates, for example, 10-bit drive data dA that defines the waveform of the drive signal Com based on the clock signal CLK and the waveform designation signal dCom. For example, the DAC interface 21 is realized by a DDS. The DDS is an abbreviation for a direct digital synthesizer. Specifically, the DAC interface 21 includes an accumulative adder that accumulates the clock signal CLK and an output circuit including a lookup table that stores the waveform designation signal dCom. The waveform designation signal dCom indicates a value of the potential of the drive signal Com, for divisions obtained by dividing a unit period Tu, which is to be described later, by the frequency of the clock signal CLK. In the following description, the number obtained by dividing the unit period Tu by the frequency of the clock signal CLK may be referred to as a clock number in a unit period N_{CLK}. Specifically, when the clock number in a unit period N_{CLK} is 16, the lookup table stores the value of the potential of the drive signal Com at the time of the 0th clock from the value of the potential of the drive signal Com at the time of the 15th clock. The output circuit outputs the value of the potential of the drive signal Com according to the value indicated by the cumulative adder from the lookup table.

The drive data dA is input to the DAC section 22. The DAC section 22 converts the input drive data dA into the base drive signal aA of an analog signal.

The base drive signal aA is input to the modulator 23. The modulator 23 outputs a modulation signal Ms obtained by performing a pulse width modulation on the base drive signal aA. A voltage VHV, a voltage GVDD, and the modulation signal Ms are input to the gate driver 24. The voltage VHV is, for example, a direct current voltage of 42 volts. The voltage GVDD is output from the voltage generation section 30 included in the amplification control signal generation circuit 20. The gate driver 24 amplifies the input modulation signal Ms based on the voltage GVDD and generates the amplification control signal Hgd that is level-shifted to a high amplitude logic based on the voltage VHV, and the amplification control signal Lgd obtained by inverting a logic level of the input modulation signal Ms and amplifying the modulation signal MS based on the voltage GVDD. That is, the logic levels of the amplification control signal Hgd and the amplification control signal Lgd are exclusive to each other. The amplification control signal Hgd and the amplification control signal Lgd are input to the drive signal output circuit 25.

The drive signal output circuit 25 outputs the drive signal Com by operating based on the amplification control signal Hgd and the amplification control signal Lgd. The drive signal output circuit 25 includes a transistor 2501, a transistor 2502, a coil 2503, and a capacitor 2504. Each of the transistors 2501 and 2502 is, for example, an N-channel type FET. The FET is an abbreviation for a field effect transistor.

The voltage VHV is supplied to a drain terminal of the transistor 2501. The amplification control signal Hgd is supplied to a gate terminal of the transistor 2501. A source terminal of the transistor 2501 is electrically coupled to a drain terminal of the transistor 2502. In addition, the amplification control signal Lgd is supplied to a gate terminal of the transistor 2502. A source electrode of the transistor 2502 is coupled to the ground. The transistor 2501 coupled as described above operates according to the amplification control signal Hgd, and the transistor 2502 operates according to the amplification control signal Lgd. That is, the transistors 2501 and 2502 are exclusively turned on. Thereby, the amplification modulation signal obtained by amplifying the modulation signal Ms based on the voltage VHV is generated at a coupling point between the source terminal of the transistor 2501 and the drain terminal of the transistor 2502. That is, the transistor 2501 and the transistor 2502 function as an amplification circuit.

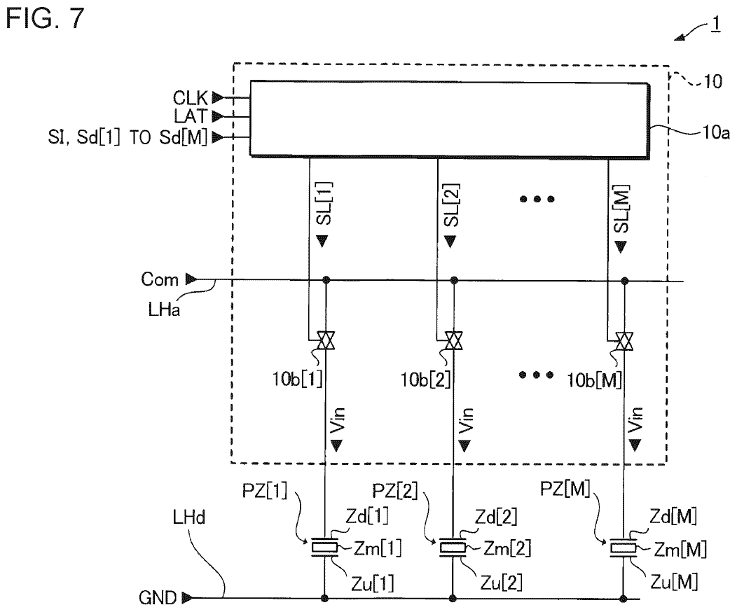

One end of the coil 2503 is commonly coupled to the source terminal of the transistor 2501 and the drain terminal of the transistor 2502. In addition, the other end of the coil 2503 is coupled to one end of the capacitor 2504. The other end of the capacitor 2504 is coupled to the ground. That is, the coil 2503 and the capacitor 2504 form a low-pass filter. Then, the amplification modulation signal is supplied to the low-pass filter, so that the amplification modulation signal is demodulated, and the drive signal Com is generated. As described above, the drive signal Com is a signal generated by the switching operation of the drive signal output circuit 25, more specifically, the switching operation of the transistor 2501 and the transistor 2502. The drive signal Com generated in the period during which the printing operation and the printing-related minute vibration operation are performed is a sine wave alternating current or a non-sine wave alternating current, and is a signal including a trapezoidal wave in the present embodiment. The drive signal Com generated by the drive signal output circuit 25 is output from the drive signal generation circuit 2 and input to the switching circuit 10. The configuration of the switching circuit 10 will be described with reference to FIG. 7.

### A4. Configuration of Switching Circuit 10

FIG. 7 is a block diagram illustrating an example of a configuration of the switching circuit 10. The liquid ejecting head 1 includes an internal wiring LHa to which the drive signal Com is supplied from the drive signal generation circuit 2, and an internal wiring LHd coupled to a ground potential GND.

In the example of FIG. 7, the one switching circuit 10 controls the M piezoelectric elements PZ respectively corresponding to the M nozzles N composing the one nozzle column Ln. The internal wiring LHd is electrically coupled to the upper electrodes Zu[m] for all m from 1 to M.

As illustrated in FIG. 7, the switching circuit 10 includes M selection circuits 10b[1] to 10b[M] that select whether or not to supply the drive signal Com as a drive signal Vin to the piezoelectric elements PZ[1] to PZ[M], and a coupling state designation circuit 10a that designates the coupling state of the M selection circuits 10b. The coupling state designation circuit 10a generates coupling state designation signals SL[1] to SL[M] that designates the M selection circuits 10b[1] to 10b[M] to be in an on-state or an off-state based on the image signal SI that is supplied from the control section 7, the clock signal CLK, and a latch signal LAT that defines the unit period Tu of the waveform included in the drive signal Com.

For example, although not illustrated, the coupling state designation circuit 10a includes a plurality of transfer circuits, a plurality of latch circuits, and a plurality of decoders to correspond to the piezoelectric elements PZ[1] to PZ[M] in a one-to-one manner. Among these, the image signal SI is supplied to the transfer circuit. Here, the image signal SI includes an individual designation signal Sd for each of the piezoelectric elements PZ. The individual designation signal Sd is serially supplied, and for example, the individual designation signal Sd is sequentially transferred to a plurality of transfer circuits in synchronization with the clock signal CLK. The latch circuit latches the individual designation signal Sd supplied to the transfer circuit based on the latch signal LAT. In addition, the decoder generates the coupling state designation signal SL[m] for each of the integers m ranging from 1 to M based on the individual designation signal Sd and the latch signal LAT.

For any integer m from 1 to M, the selection circuit 10b[m] switches between conduction and non-conduction of the internal wiring LHa and the lower electrode Zd[m] of the piezoelectric element PZ[m] according to the coupling state designation signal SL[m]. For example, the selection circuit 10b[m] is turned on when the coupling state designation signal SL[m] is at a high level, and is turned off when the coupling state designation signal SL[m] is at a low level. The upper electrode Zu[m] of the piezoelectric element PZ[m] is coupled to the reference potential Vbs. The piezoelectric element PZ[m] is driven according to the potential difference between the drive signal Vin and the reference potential Vbs. The nozzle N[m] ejects an amount of ink according to the potential difference.

### A5. Drive Signal Com

FIG. 8 is a diagram describing the drive signal Com. The drive signal Com has a start potential holding element as, an ejection waveform PD, and an end potential holding element ae in the one unit period Tu. The ejection waveform PD has a first expansion element EF1, a first holding element PW1, a contraction element ET, a second holding element PW2, and a second expansion element EF2 in this order. The drive signal Com may not include one of the start potential holding element as and the end potential holding element ae in the one unit period Tu. The first expansion element EF1 is an example of an “expansion element”.

The start potential holding element as is an element that holds a reference potential E0 from the start of the one unit period Tu to the start of the ejection waveform PD. The end potential holding element ae is an element that holds the reference potential E0 from the end of the ejection waveform PD to the end of the one unit period Tu.

The first expansion element EF1 changes the potential to expand the pressure chamber CV. Specifically, the first expansion element EF1 changes the potential from the reference potential E0, which is the start potential of the ejection waveform PD, to a lowest potential EL. The first holding element PW1 is coupled to the termination of the first expansion element EF1 and holds the lowest potential EL. The contraction element ET is coupled to the termination of the first holding element PW1 and changes the potential to contract the pressure chamber CV. Specifically, the contraction element ET changes the potential from the lowest potential EL to a highest potential EH. The second holding element PW2 is coupled to the termination of the contraction element ET and holds the highest potential EH. The second expansion element EF2 is coupled to the termination of the second holding element PW2 and changes the potential to expand the pressure chamber CV. Specifically, the second expansion element EF2 changes the potential from the highest potential EH to the reference potential E0.

The first expansion element EF1 causes a negative pressure to be generated in the pressure chamber CV, so that the liquid level of the ink in the nozzle N is drawn in the Z1 direction. In the following, the liquid level of the ink in the nozzle N may be referred to as a “meniscus”. In addition, the act of drawing the meniscus in the Z1 direction may be referred to as “pull”. The contraction element ET causes a positive pressure to be generated in the pressure chamber CV, so that the meniscus is pushed in the Z2 direction, and the ink is ejected in the Z2 direction. Hereinafter, the act of pushing the meniscus in an ejection direction may be referred to as “push”. The second expansion element EF2 causes a negative pressure to be generated in the pressure chamber CV, so that the meniscus is drawn in the Z1 direction. The ejection waveform PD is a so-called pull-push-pull waveform.

The drive signal Com may have a waveform different from the ejection waveform PD. For example, the drive signal Com may have a waveform having the first expansion element EF1, the first holding element PW1, the contraction element ET, and the second holding element PW2. That is, the drive signal Com may have a so-called pull-push waveform that does not have the second expansion element EF2.

The waveform information CI illustrated in FIG. 1 indicates the waveform shape included in the drive signal Com. Specifically, the waveform information CI has termination information including information indicating the time of the termination of each element included in the drive signal Com and information indicating the potential of the termination. For example, the waveform information CI has the termination information of the start potential holding element as, the termination information of the first expansion element EF1, the termination information of the first holding element PW1, the termination information of the contraction element ET, the termination information of the second holding element PW2, the termination information of the second expansion element EF2, and the termination information of the end potential holding element ae. The information indicating the time of the termination included in the termination information of the end potential holding element ae indicates the one unit period Tu.

For example, when the ground potential GND is 0 [V], the reference potential Vbs is 6 [V], the lowest potential EL is 2.5 [V], and the highest potential EH is 27.5 [V]. A potential difference ΔEh between the highest potential EH and the lowest potential EL is 25 [V]. The reference potential E0 is an average voltage of the highest potential EH and the lowest potential EL.

FIG. 9 is a diagram illustrating a change in voltage when the drive signal Com is supplied to the piezoelectric element PZ. In the present specification, for simplification of the description, the difference in potential from the reference potential Vbs supplied to the upper electrode Zu is referred to as a “voltage”. As illustrated in FIG. 9, the reference voltage V0, which is the start voltage of the first expansion element EF1, is a voltage obtained by subtracting 6 [V] from the reference potential E0. The lowest voltage VL, which is the end voltage of the first expansion element EF1, is −3.5 [V]. The highest voltage VH, which is the end voltage of the contraction element ET, is 21.5 [V]. A potential difference ΔVh between the highest voltage VH and the lowest voltage VL is the same as the potential difference ΔEh and is 25 [V].

### A6. Characteristics of Piezoelectric Element PZ

The piezoelectric element PZ has a characteristic that it takes a certain period of time until the current is stabilized after the potential of the drive signal Com supplied to the piezoelectric element PZ fluctuates. Hereinafter, a period until the current is stabilized after the potential of the drive signal Com fluctuates may be referred to as an “inversion period”. Further, the inversion period that occurs immediately after the end of the first expansion element EF1 may be referred to as a “pull inversion period”, the inversion period that occurs immediately after the end of the contraction element ET may be referred to as a “push inversion period”, and the inversion period that occurs immediately after the end of the second expansion element EF2 may be referred to as a “reset inversion period”. Hereinafter, the pull inversion period, the push inversion period, and the reset inversion period may be collectively referred to as an inversion period. When the inversion period is long, it means that it takes time for the current to follow the potential change. Therefore, it is necessary to lengthen the period for holding the potential after the change according to the length of the inversion period. Then, the potential of the drive signal Com supplied to the piezoelectric element PZ after the inversion period is expired is fluctuated, so that the characteristics of the piezoelectric element PZ can be sufficiently drawn out. For example, when the contraction element ET is supplied to the piezoelectric element PZ before the pull inversion period is expired, the pressure chamber CV is contracted before the pressure chamber CV is sufficiently expanded, so that the ejection characteristics such as the ejection amount and the ejection rate are lowered, and the characteristics of the piezoelectric element PZ cannot be sufficiently drawn out.

Here, the length of the inversion period may fluctuate. In addition, it was unknown when the inversion period is expired. As an example of a method of sufficiently drawing out the characteristics of the piezoelectric element PZ, there is an aspect in which the potential of the drive signal Com is fluctuated with the inversion period being considered as a sufficiently long period. However, in the aspect, when the inversion period is short, since the voltage supplied to the piezoelectric element PZ is unnecessarily held, there is a problem from the viewpoint of the circuit load and the power consumption. As described above, since it is unknown when the inversion period is expired, there is a problem that the drive signal Com cannot be appropriately supplied to the M piezoelectric elements PZ.

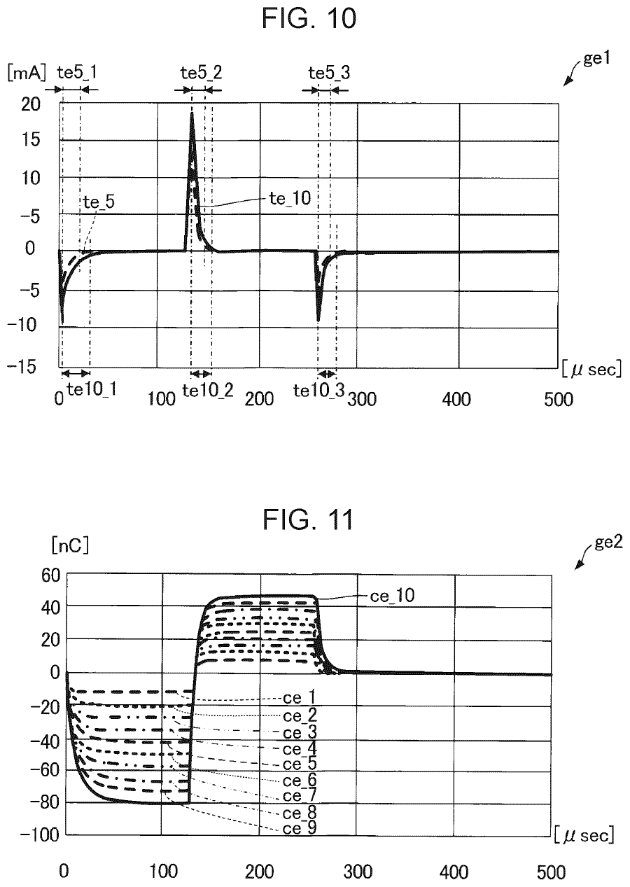

Therefore, the inventor investigated the length of the inversion period, so that, as a result of the experiment, it was obtained that the simultaneous drive number N_{PZ}, which is the number of piezoelectric elements PZ driven at the same time, and the inversion period are proportional to each other. In the present specification, the piezoelectric elements PZ driven at the same time mean the piezoelectric elements PZ driven in the same unit period Tu. Further, the inventor can theoretically prove that the simultaneous drive number N_{PZ} and the inversion period are proportional to each other. The inventor measured the current and the charge amount when the ejection waveform PD is supplied to the piezoelectric element PZ for each of the integers of the simultaneous drive number N_{PZ} from 1 to 10. Hereinafter, the measurement result will be described with reference to FIGS. 10, 11, 12, and 13.

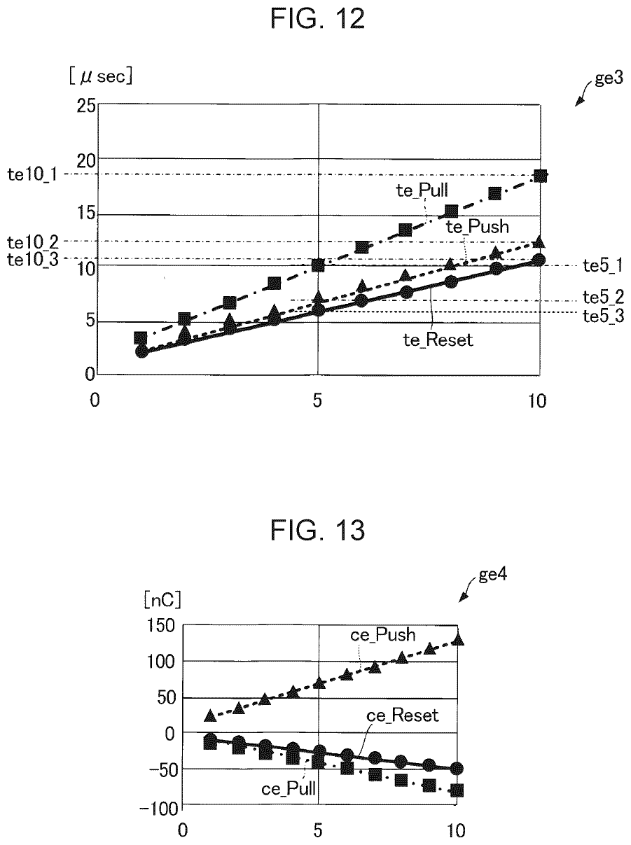

FIG. 10 is a diagram illustrating a measurement result of a current response when the ejection waveform PD is supplied to the piezoelectric element PZ. However, in order to avoid complications of the drawing, in FIG. 10, among the measurement results for each of the integers of the simultaneous drive number N_{PZ} from 1 to 10, only the measurement results when the simultaneous drive number N_{PZ} is 5 or 10 are illustrated. FIG. 11 is a diagram illustrating the measurement result of the charge amount response when the ejection waveform PD is supplied to the piezoelectric element PZ for each of the integers of the simultaneous drive number N_{PZ} from 1 to 10. FIG. 12 is a diagram illustrating a determination period for each of the integers of the simultaneous drive number N_{PZ} from 1 to 10. FIG. 13 is a diagram illustrating a polarization amount for each of the integers of the simultaneous drive number N_{PZ} from 1 to 10. In the drive signal Com supplied to the piezoelectric element PZ in FIGS. 10, 11, 12, and 13, the period of the first expansion element EF1, the period of the contraction element ET, and the period of the second expansion element EF2 are 2.5 [μsec], and the period of the first holding element PW1 and the period of the second holding element PW2 are 125 [μsec]. The period of the end potential holding element ae is 242.5 [μsec]. [μsec] means microsecond.

Further, in the following description, the inversion period is a period from when the potential of the drive signal Com is finished fluctuating to when a current of 10% or more of the maximum current flows.

The horizontal axis of a graph ge1 illustrated in FIG. 10 indicates the time, and the vertical axis of the graph ge1 indicates the magnitude of the current. A current characteristic te_5 illustrated in the graph ge1 indicates the characteristic of the current when the simultaneous drive number N_{PZ} is 5. A current characteristic te_10 illustrated in the graph ge1 indicates the characteristic of the current when the simultaneous drive number N_{PZ} is 10. The horizontal axis of a graph ge2 illustrated in FIG. 11 indicates the time, and the vertical axis of the graph ge2 indicates the charge amount. [nC] in the graph ge2 means nano-curlon. Each of charge amount characteristics ce_1, ce_2, ce_3, ce_4, ce_5, ce_6, ce_7, ce_8, ce_9, and ce_10 illustrated in the graph ge2 indicates the characteristic of the charge amount when the simultaneous drive number N_{PZ} is each of the integers from 1 to 10.

The horizontal axis of a graph ge3 illustrated in FIG. 12 indicates the simultaneous drive number N_{PZ}, and the vertical axis of the graph ge3 indicates the inversion period. The graph ge3 illustrates an inversion period characteristic te_Pull, an inversion period characteristic te_Push. and an inversion period characteristic te_Reset. The inversion period characteristic te_Pull indicates the characteristic of the pull inversion period. The inversion period characteristic te_Push indicates the characteristic of the push inversion period. The inversion period characteristic te_Reset indicates the characteristic of the reset inversion period. The horizontal axis of a graph ge4 illustrated in FIG. 13 indicates the simultaneous drive number N_{PZ}, and the vertical axis of the graph ge4 indicates the polarization amount. The graph ge4 illustrates a polarization amount characteristic ce_Pull, a polarization amount characteristic ce_Push, and a polarization amount characteristic ce_Reset. The polarization amount characteristic ce_Pull indicates the characteristic of the polarization amount from immediately after the start of the first expansion element EF1. The polarization amount characteristic ce_Push indicates the characteristic of the polarization amount from immediately after the start of the contraction element ET. The polarization amount characteristic ce_Reset indicates the characteristic of the polarization amount immediately after the start of the second expansion element EF2.

For example, as indicated by the inversion period characteristic te_Pull and the current characteristic te_5, a pull inversion period te5_1 when the simultaneous drive number N_{PZ} is 5 is substantially 10.1 [μsec]. In addition, as indicated by the inversion period characteristic te_Push and the current characteristic te_5, a push inversion period te5_2 when the simultaneous drive number N_{PZ} is 5 is substantially 7.0 [μsec]. In addition, as indicated by the inversion period characteristic te_Reset and the current characteristic te_5, a reset inversion period te5_3 when the simultaneous drive number N_{PZ} is 5 is substantially 6.1 [μsec].

In addition, as indicated by the inversion period characteristic te_Pull and the current characteristic te_10, a pull inversion period te10_1 when the simultaneous drive number N_{PZ} is 10 is substantially 18.5 [μsec]. In addition, as indicated by the inversion period characteristic te_Push and the current characteristic te_10, a push inversion period te10_2 when the simultaneous drive number N_{PZ} is 10 is substantially 12.4 [μsec]. In addition, as indicated by the inversion period characteristic te_Reset and the current characteristic te_10, a reset inversion period te10_3 when the simultaneous drive number N_{PZ} is 10 is substantially 10.7 [μsec].

As illustrated by the inversion period characteristic te_Pull, the inversion period characteristic te_Push. and the inversion period characteristic te_Reset, when the simultaneous drive number N_{PZ} increases, the inversion period increases at a ratio substantially the same as the ratio at which the simultaneous drive number N_{PZ} increases, so that it can be presumed that the simultaneous drive number N_{PZ} and the inversion period are in a proportional relationship. Similarly, as indicated by the polarization amount characteristic ce_Pull, the polarization amount characteristic ce_Push, and the polarization amount characteristic ce_Reset, it can be presumed that the simultaneous drive number N_{PZ} and the polarization amount are in a proportional relationship.

Next, a theory that the simultaneous drive number N_{PZ} and the inversion period are proportional will be described. The individual piezoelectric elements PZ are coupled in parallel. Therefore, as indicated by the polarization amount characteristic ce_Pull, the polarization amount characteristic ce_Push, and the polarization amount characteristic ce_Reset, in proportion to the number of piezoelectric elements PZ driven at the same time, the combined capacitance when the piezoelectric elements PZ driven at the same time are regarded as the one piezoelectric element PZ increases. When the number of piezoelectric elements PZ driven at the same time increases, the combined capacitance increases, but when the influence of the increased combined capacitance is not considered in the ejection waveform PD, the state of the piezoelectric element PZ at the time that the selection circuit 10b is switched by the image signal SI depends on the simultaneous drive number N_{PZ}, so that the characteristics of the piezoelectric element PZ cannot be sufficiently drawn out, which the inventor considered. The inventor calculated the current during the fluctuation of the voltage supplied to the piezoelectric element PZ and the current after the fluctuation of the voltage ended.

A current J when the voltage supplied to the piezoelectric element PZ fluctuates is represented by Expression 1 below.

$$J = C \times Δ V / Δ t \times [ 1 - exp ( ‐ \frac{t}{RC} ) ] \qquad ( 1 )$$

However, C indicates the combined capacitance of the entire piezoelectric element PZ driven at the same time, V indicates a voltage applied to the piezoelectric element PZ, R indicates a resistance in the circuit including the drive signal generation circuit 2 and the piezoelectric element PZ, and t indicates an elapsed period. exp(x) is a function that calculates e raised to the power of x. e is a Napier number. The current J when the voltage of the piezoelectric element PZ is constant is represented by Expression (2) below.

$$J = {J}_{0} \times exp ( - \frac{t}{RC} ) \qquad ( 2 )$$

However, J₀ is a current when a constant voltage is reached. In other words, J₀ may be said to be the current at the time that the fluctuation of the voltage supplied to the piezoelectric element PZ is ended.

The inventor calculated the current due to the fluctuation of the voltage by the contraction element ET for each of the integers of the simultaneous drive number N_{PZ} from 1 to 10 using Expression (1) and Expression (2). More specifically, the inventor calculated the current J in a state where the voltage fluctuates between 0 [μsec] and 2.5 [μsec] for each of the integers of the simultaneous drive number N_{PZ} from 1 to 10 by Expression (1), and calculated the current J after 2.5 [μsec] by Expression (2).

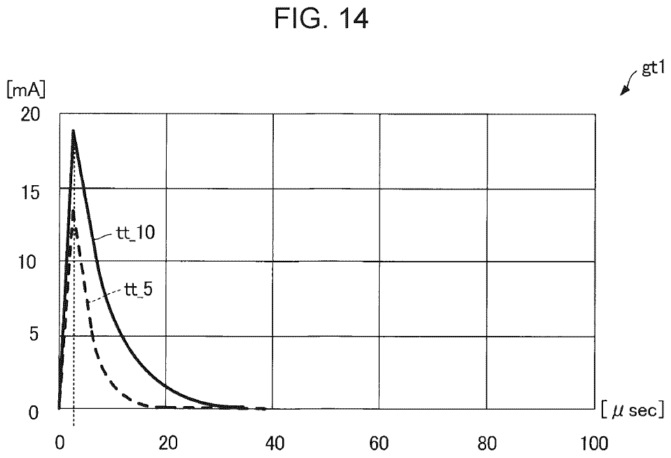

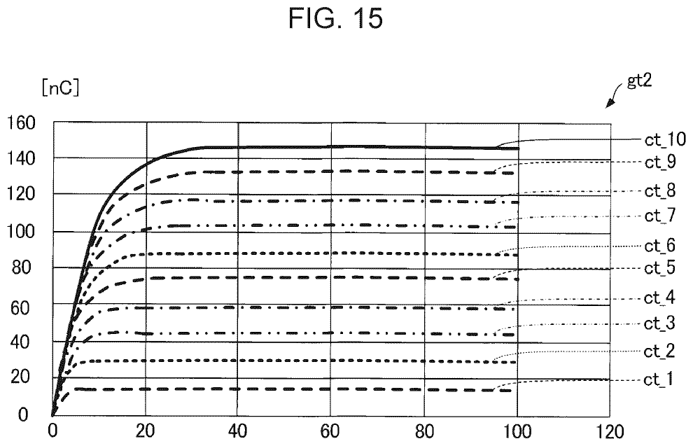

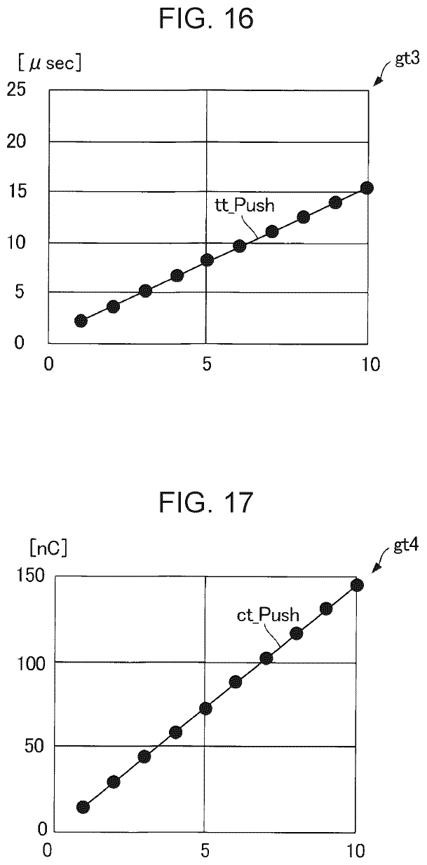

FIG. 14 is a diagram illustrating the value of the current calculated by Expression (1) and Expression (2). However, in order to avoid complication of the drawing, in FIG. 14, among the calculation results for each of the integers of the simultaneous drive number N_{PZ} from 1 to 10, only the calculation results when the simultaneous drive number N_{PZ} is 5 or 10 are illustrated. FIG. 15 is a diagram illustrating the charge amount based on the current of FIG. 14. The polarization amount is obtained by integrating the current. FIG. 16 is a diagram illustrating the length of the push inversion period based on the current calculated by Expression (1) and Expression (2) for each of the integers of the simultaneous drive number N_{PZ} from 1 to 10. FIG. 17 is a diagram illustrating the polarization amount based on the current calculated by Expression (1) and Expression (2) for each of the integers of the simultaneous drive number N_{PZ} from 1 to 10.

The horizontal axis of the graph gt1 illustrated in FIG. 14 indicates a period from the start of the voltage fluctuation. The vertical axis of the graph gt1 indicates the magnitude of the current calculated by Expression (1) and Expression (2). A current characteristic tt_5 illustrated in the graph gt1 indicates the characteristic of the current calculated by Expression (1) and Expression (2) when the simultaneous drive number N_{PZ} is 5. A current characteristic tt_10 illustrated in the graph gt1 indicates the characteristic of the current calculated by Expression (1) and Expression (2) when the simultaneous drive number N_{PZ} is 10. The horizontal axis of the graph gt2 illustrated in FIG. 15 indicates the time, and the vertical axis of the graph gt2 indicates the charge amount. Each of the charge amount characteristics ce_1, ce_2, ce_3, ce_4, ce_5, ce_6, ce_7, ce_8, ce_9, and ce_10 illustrated in the graph gt2 indicates the characteristic of the charge amount based on the calculation results of Expression (1) and Expression (2) when the simultaneous drive number N_{PZ} is each of the integers from 1 to 10.

The horizontal axis of a graph gt3 illustrated in FIG. 16 indicates the simultaneous drive number N_{PZ}, and the vertical axis of the graph gt3 indicates the push inversion period. An inversion period characteristic tt_Push indicated by the graph gt3 indicates the inversion period after 2.5 [μsec] for each of the integers of the simultaneous drive number N_{PZ} from 1 to 10. The horizontal axis of a graph gt4 illustrated in FIG. 17 indicates the simultaneous drive number N_{PZ}, and the vertical axis of the graph gt4 indicates the polarization amount. The polarization amount characteristic ct_Push illustrated by the graph gt4 indicates the characteristic of the polarization amount when the simultaneous drive number N_{PZ} is each of the integers from 1 to 10.

As indicated by the inversion period characteristic tt_Push, the simultaneous drive number N_{PZ} and the push inversion period are in a proportional relationship. Further, as indicated by the polarization amount characteristic ct_Push, the simultaneous drive number N_{PZ} and the polarization amount are in a proportional relationship. Further, it is found that the inversion period characteristic te_Push and the inversion period characteristic tt_Push substantially match, and the polarization amount characteristic ce_Push and the polarization amount characteristic ct_Push substantially match.

Expression (2) is modified to prove that the inversion period is proportional to the simultaneous drive number N_{PZ}. The combined capacitance C is represented by Expression (3) below.

$$C = {C}_{unit} {N}_{PZ} \qquad ( 3 )$$

However, Cᵤₙᵢₜ indicates the capacitance of the one piezoelectric element PZ. By substituting Expression (3) into Expression (2), dividing both sides by J₀, and taking the logarithm of both sides with the base of the Napier number e, that is, the natural logarithm, Expression (4) below is obtained.

$$ln ( J / {J}_{0} ) = - t / {RC}_{unit} {N}_{PZ} \qquad ( 4 )$$

However, ln(x) is a function of acquiring the natural logarithm of x. When the current J at the point in time when the inversion period is expired is denoted as Jᵢₙᵥ and the length of the inversion period is denoted as tᵢₙᵥ, Expression (5) is obtained.

$$ln ( {J}_{inv} / {J}_{0} ) = - {t}_{inv} / {RC}_{unit} {N}_{PZ} \qquad ( 5 )$$

According to the definition of the inversion period in the present specification, Jᵢₙᵥ/J₀ is 0.1. ln(0.1) is substantially −2.303. Therefore, Expression (5) can be modified into Expression (6) below.

$${t}_{inv} = 2.3 \; 03 {RC}_{unit} {N}_{PZ} \qquad ( 6 )$$

R is a value that does not substantially fluctuate during one printing process and can be regarded as a constant. Cᵤₙᵢₜ is a value that does not substantially fluctuate in the same element in each of the two or more unit periods Tu of the drive signal Com during one printing process, and can be regarded as a constant. Therefore, as indicated by Expression (6), it can be said that tᵢₙᵥ indicating the inversion period is proportional to the simultaneous drive number N_{PZ}.

In the printing process, the liquid ejecting apparatus 100 according to the present embodiment adjusts the timing of changing the potential of the drive signal Com according to the simultaneous drive number N_{PZ} by using the fact that the inversion period is proportional to the simultaneous drive number N_{PZ}, and outputs the drive signal Com of which the potential is changed at the adjusted timing. In the following description, a timing at which the potential of the drive signal Com is changed may be referred to as a “potential change timing”.

As illustrated in FIG. 1, the liquid ejecting apparatus 100 includes the image signal output section 71, the acquisition section 73, the determination section 70, and the drive signal generation circuit 2. The image signal output section 71 generates the image signal SI based on the printing data Img, and outputs the image signal SI to the liquid ejecting head 1. The acquisition section 73 acquires the simultaneous drive number N_{PZ} from the image signal SI. The determination section 70 determines the drive signal Com by adjusting the potential change timing based on the simultaneous drive number N_{PZ}. The drive signal generation circuit 2 outputs the drive signal Com determined by the determination section 70 to the liquid ejecting head 1.

### A7. Operation of Printing Process in First Embodiment

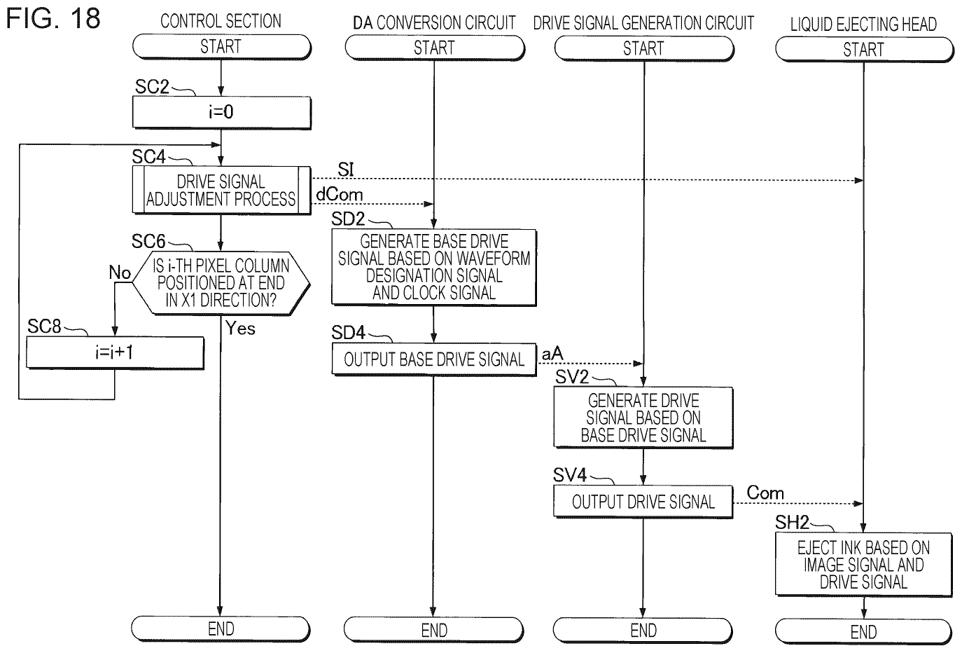

The printing process has two modes, bidirectional printing and unidirectional printing. The present disclosure can be applied to both bidirectional printing and unidirectional printing. Hereinafter, for simplification of the description, an aspect in which the present disclosure is applied to unidirectional printing will be described. In the following description, moving the liquid ejecting head 1 once in a main scanning direction is referred to as one pass. In the unidirectional printing, the liquid ejecting apparatus 100 executes an X1-direction printing process of ejecting the ink while the liquid ejecting head 1 is moved in the X1 direction to form a partial image corresponding to the first pass on the medium PP. Next, the liquid ejecting apparatus 100 executes a moving process of transporting the medium PP for one pass and moving the liquid ejecting head 1 to an end portion in the X2 direction. Thereafter, the liquid ejecting apparatus 100 repeats the X1-direction printing process and the moving process until an image is formed at the medium PP. The X1-direction printing process will be described with reference to FIG. 18.

FIG. 18 is a flowchart illustrating a series of processes of the printing process. Although omitted in FIG. 18 to avoid complication of the drawing, after the power of the liquid ejecting apparatus 100 is turned on, the oscillation circuit 4 supplies the clock signal CLK at a constant cycle to the control section 7, the DA conversion circuit 3, and the liquid ejecting head 1.

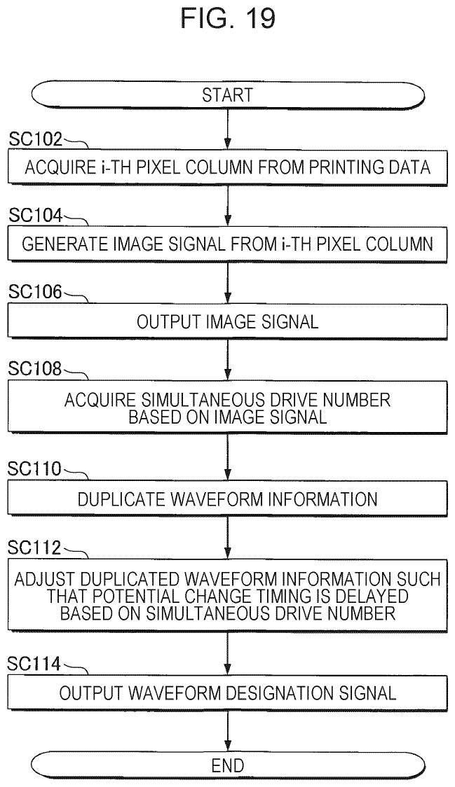

When the user of the liquid ejecting apparatus 100 gives an instruction to execute the printing process, the control section 7 substitutes 0 for a variable i in a step SC2, and executes a drive signal adjustment process in a step SC4. The drive signal adjustment process will be described with reference to FIG. 19.

FIG. 19 is a flowchart illustrating a series of processes of the drive signal adjustment process. In a step SC102, the control section 7 acquires the i-th pixel column from a set of pixels composing the partial image for one pass in the image indicated by the printing data Img. Here, the pixel column is a set of pixels in the direction along the nozzle column Ln. In the first embodiment, the pixel column is a set of M pixels in the direction along the Y-axis.

After the process of the step SC102 is ended, the control section 7 functions as the image signal output section 71 and generates the image signal SI from the i-th pixel column in a step SC104. Specifically, for each of the integers m from 1 to M, which is the i-th pixel column, in a case of a pixel in which a dot is to be formed, the individual designation signal Sd[m] indicating that the ink is ejected from the nozzle N[m] is generated, and in a case of a pixel in which a dot is not to be formed, the individual designation signal Sd[m] indicating that the ink is not ejected from the nozzle N[m] is generated. After the process of the step SC104 is ended, the control section 7 functions as the image signal output section 71 and outputs the image signal SI to the liquid ejecting head 1 in a step SC106.

After the process of the step SC106 is ended, the control section 7 functions as the acquisition section 73 and acquires the simultaneous drive number N_{PZ} based on the image signal SI in a step SC108. Specifically, the control section 7 acquires the number of individual designation signals Sd indicating that the ink is ejected from the nozzle N[m] among the M individual designation signals Sd included in the image signal SI, as the simultaneous drive number N_{PZ}. Alternatively, the control section 7 may acquire the number of individual designation signals Sd indicating that the ink is not ejected from the nozzle N[m] among the M individual designation signals Sd included in the image signal SI, and may acquire a value obtained by subtracting the acquired number from M, as the simultaneous drive number N_{PZ}. The control section 7 may execute the process of the Step SC108 after the process of the step SC104 is ended and before the process of the step SC106.

After the process of the step SC108 is ended, in a step SC110, the control section 7 duplicates the waveform information CI stored in the storage section 5. The control section 7 may execute the process of the step SC110 before the process of the step SC108 is ended.

After the process of the step SC110 is ended, the control section 7 functions as the waveform designation signal output section 75 and, in a step SC112, adjusts the duplicated waveform information CI such that the potential change timing is delayed based on the simultaneous drive number N_{PZ}. For example, the control section 7 adjusts the waveform information CI such that one or both of the period of the first holding element PW1 and the period of the second holding element PW2 are extended according to the increase in the simultaneous drive number N_{PZ}. In the present embodiment, the control section 7 sets both the period of the first holding element PW1 and the period of the second holding element PW2 to be long. In the following description, the period extended based on the simultaneous drive number N_{PZ} may be referred to as an “extension period”. Further, the extension period of the first holding element PW1 may be referred to as a “pull extension period”, and the extension period of the second holding element PW2 may be referred to as a “push extension period”. Further, the pull extension period and the push extension period may be collectively referred to as the extension period. In the first embodiment, the pull extension period and the push extension period are equal.

For example, the control section 7 sets the extension period to 0 when the simultaneous drive number N_{PZ} is less than a first threshold value, sets the extension period to the first integer multiple of the adjustment cycle T_{CLK} when the simultaneous drive number N_{PZ} is equal to or greater than the first threshold value and less than a second threshold value, and sets the extension period to the second integer multiple of the adjustment cycle T_{CLK} when the simultaneous drive number N_{PZ} is equal to or greater than the second threshold value. The first threshold value is an integer of 1 or greater and M or less. The second threshold value is an integer that is 1 or greater and M or less and that is larger than the first threshold value. The first integer is an integer of 1 or greater and less than the clock number in a unit period N_{CLK}. The second integer is an integer that is 1 or greater and less than the clock number in a unit period N_{CLK} and that is larger than the first integer.

The i-th pixel column is an example of the “first pixel column”. The integer that is equal to or greater than the first threshold value and less than the second threshold value is an example of the “first number”, and the integer that is equal to or greater than the second threshold value and equal to or less than M is an example of the “second number”. The first integer multiple of the adjustment cycle T_{CLK} is an example of the “first period” and the “third period”. The second integer multiple of the adjustment cycle T_{CLK} is an example of the “second period” and the “fourth period”. That is, in the first embodiment, the “first period” and the “third period” are equal, and the “second period” and the “fourth period” are equal.

The second integer multiple of the adjustment cycle T_{CLK} preferably satisfies, for example, Expression (7) below.

$${T}_{CLK} \times second integer \geq 2.303 {RC}_{unit} {N}_{PZ} \qquad ( 7 )$$

The right side of Expression (7) is the same as the right side of Expression (6).

For example, when the simultaneous drive number N_{PZ} is equal to or greater than the first threshold value and less than the second threshold value, the control section 7 sets the time of the termination included in the termination information of the first holding element PW1 and the termination information of the contraction element ET of the waveform information CI, to be delayed by the first integer multiple of the adjustment cycle T_{CLK} within a range not exceeding the unit period Tu. The time of the termination of the element after the second holding element PW2 is required to add the pull extension period, which is the extension period of the first holding element PW1, in addition to the push extension period, which is the extension period of the second holding element PW2. Therefore, the control section 7 sets the time of the termination included in the termination information of the second holding element PW2 and the termination information of the second expansion element EF2 of the waveform information CI, to be delayed by two times of the first integer multiple of the adjustment cycle T_{CLK} within a range not exceeding the unit period Tu. A specific example of the process of the step SC112 will be described after the description of the series of processes illustrated in FIGS. 18 and 19 is ended.

After the process of the step SC112 is ended, the control section 7 functions as the waveform designation signal output section 75, generates the waveform designation signal dCom based on the adjusted waveform information CI in a step SC114, and outputs the waveform designation signal dCom to the DA conversion circuit 3. Specifically, the control section 7 refers to the adjusted waveform information CI and generates the waveform designation signal dCom from the value of the potential of the drive signal Com at the time of the 0-th clock to the value of the potential of the drive signal Com at the time of (the clock number in a unit period N_{CLK}−1)-th. The control section 7 writes the generated waveform designation signal dCom into the lookup table of the DAC interface 21. After the process of the step SC114 is ended, the control section 7 ends the series of processes illustrated in FIG. 19 and executes the process of a step SC6 illustrated in FIG. 18.

The description is returned to FIG. 18. When the waveform designation signal dCom is output to the DA conversion circuit 3, the DA conversion circuit 3 generates the base drive signal aA based on the waveform designation signal dCom and the clock signal CLK in a step SD2. Specifically, in the step SC114, the control section 7 writes the waveform designation signal dCom into the lookup table of the DAC interface 21. The waveform designation signal dCom is generated based on the waveform information CI in which the timing at which the potential is changed is adjusted in the step SC112. Therefore, the generated base drive signal aA has a timing for changing the potential adjusted. After the process of step SD2 is ended, in a step SD4, the DA conversion circuit 3 outputs the base drive signal aA to the drive signal generation circuit 2.

When the base drive signal aA is output to the drive signal generation circuit 2, the drive signal generation circuit 2 generates the drive signal Com based on the base drive signal aA in a step SV2. Next, the drive signal generation circuit 2 outputs the drive signal Com to the liquid ejecting head 1 in the step SV4.

When the image signal SI and the drive signal Com are output to the liquid ejecting head 1, the liquid ejecting head 1 ejects the ink to the medium PP based on the image signal SI and the drive signal Com in a step SH2.

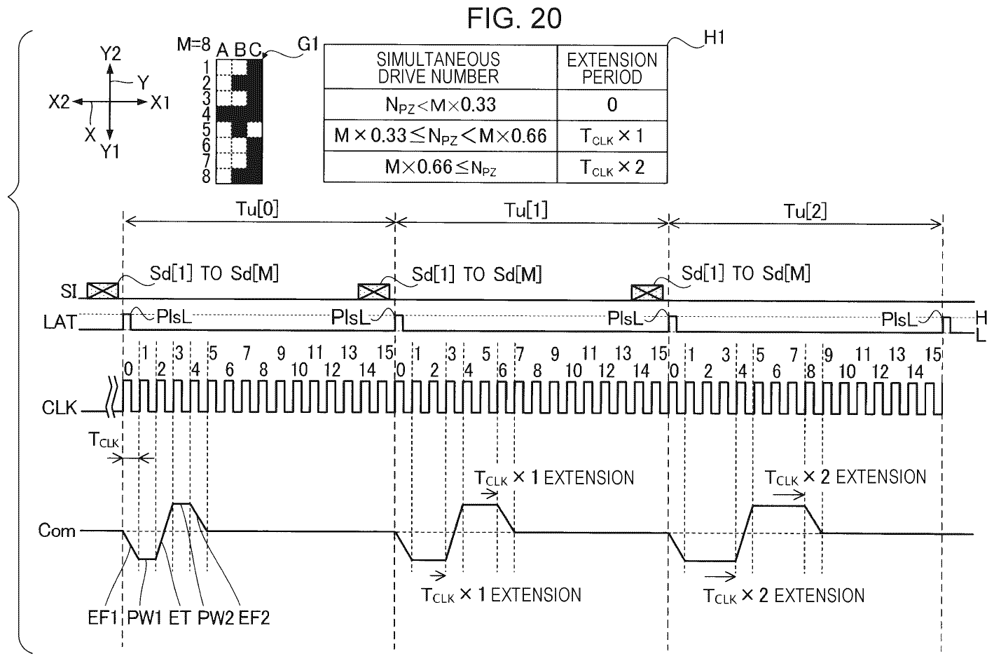

After the process of the step SC4 is ended, in the step SC6, the control section 7 determines whether or not the i-th pixel column is positioned at the end of the image in the X1 direction indicated by the printing data Img. When the determination result in the step SC6 is negative, the control section 7 adds 1 to the value of the variable i in a step SC8, and returns the process to the step SC4. When the determination result in the step SC6 is positive, the control section 7 ends the series of processes illustrated in FIG. 18. A specific example of the process of the step SC112 will be described with reference to FIG. 20.

FIG. 20 is a diagram for describing a specific example of the process of the step SC112. In FIG. 20, it is assumed that the number obtained by dividing the unit period Tu by the frequency of the clock signal CLK is 16, the number M of the nozzles N included in the liquid ejecting head 1 is 8, and an image G1 indicated by the printing data Img illustrated in FIG. 20 is formed at the medium PP. The image G1 is composed with 24 pixels. In the image G1, eight pixels are arranged in the direction along the Y-axis, and three pixels are arranged in the direction along the X-axis. Therefore, the image G1 has three pixel columns along the Y-axis. Hereinafter, the pixel column positioned at the end of the image G1 in the X2 direction is referred to as a pixel column A, the pixel column positioned at the end of the image G1 in the X1 direction is referred to as a pixel column C, and the pixel column between the pixel column A and the pixel column C is referred to as a pixel column B. The liquid ejecting apparatus 100 forms the pixel column A on the medium PP in the first unit period Tu[0], forms the pixel column B on the medium PP in the second unit period Tu[1], and forms the pixel column C on the medium PP in the third unit period Tu[2].

As illustrated in FIG. 20, the liquid ejecting apparatus 100 forms a dot for the fourth pixel counted from the end in the Y2 direction in the pixel column A, forms a dot for the second, fourth, fifth, and eighth pixels counted from the end in the Y2 direction in the pixel column B, and forms a dot for the first to fourth pixels and the sixth to eighth pixels counted from the end in the Y2 direction in the pixel column C.

Table H1 illustrated in FIG. 20 illustrates an example of the relationship between the simultaneous drive number N_{PZ} and the extension period. As illustrated in Table H1, the control section 7 sets the extension period to 0 when the simultaneous drive number N_{PZ} is less than M×0.33, sets the extension period to the one adjustment cycle T_{CLK} when the simultaneous drive number N_{PZ} is equal to or greater than M×0.33 and less than M×0.66, and sets the extension period to the two adjustment cycles T_{CLK} when the simultaneous drive number N_{PZ} is equal to or greater than M×0.66.

In the unit period Tu[0], the simultaneous drive number N_{PZ} is 1 as understood from the pixel column A, so that the simultaneous drive number N_{PZ} is less than M×0.33. Therefore, in the step SC112, the control section 7 sets the extension period to 0, that is, does not adjust the waveform information CI in any way.

In the unit period Tu[1], as understood from the pixel column B, since the simultaneous drive number N_{PZ} is 4, the simultaneous drive number N_{PZ} is equal to or greater than M×0.33 and less than M×0.66. Therefore, in the step SC112, the control section 7 sets the extension period to the one adjustment cycle T_{CLK}. That is, the control section 7 sets the time of the termination included in the termination information of the first holding element PW1 and the termination information of the contraction element ET, to be delayed by the one adjustment cycle T_{CLK}, and sets the time of the termination included in the termination information of the second holding element PW2 and the termination information of the second expansion element EF2 of the waveform information CI, to be delayed by the two adjustment cycles T_{CLK}.

In the unit period Tu[2], as understood from the pixel column C, the simultaneous drive number N_{PZ} is 7, so that the simultaneous drive number N_{PZ} is equal to or greater than M×0.66. Therefore, in the step SC112, the control section 7 sets the extension period to the two adjustment cycles T_{CLK}. That is, the control section 7 sets the time of the termination included in the termination information of the first holding element PW1 and the termination information of the contraction element ET, to be delayed by the two adjustment cycles T_{CLK}, and sets the time of the termination included in the termination information of the second holding element PW2 and the termination information of the second expansion element EF2 of the waveform information CI, to be delayed by the four adjustment cycles T_{CLK}.

In FIG. 20, the period of the first holding element PW1 and the period of the second holding element PW2 are extended by extending the times of the terminations of the first holding element PW1 and the second holding element PW2, but the present disclosure is not limited thereto. For example, the control section 7 may extend the period of the first holding element PW1 and the period of the second holding element PW2 by extending the times of the start ends of the first holding element PW1 and the second holding element PW2 in the past direction within a range not exceeding the unit period Tu.

### A8. Summary of First Embodiment

Hereinafter, the summary of the first embodiment will be described, assuming that the i-th pixel column of the image formed at the medium PP is an example of the “first pixel column”, that an integer that is equal to or greater than the first threshold value and less than the second threshold value is an example of the “first number”, that an integer that is equal to or greater than the second threshold value and equal to or less than M is an example of the “second number”, and that the first integer multiple of the adjustment cycle T_{CLK} is an example of the “first period” and the “third period”, and the second integer multiple of the adjustment cycle T_{CLK} is an example of the “second period” and the “fourth period”.

The liquid ejecting apparatus 100 includes the liquid ejecting head 1, the acquisition section 73, the determination section 70, and the drive signal generation circuit 2. The liquid ejecting head 1 is provided with a plurality of piezoelectric elements PZ that apply pressure to the ink in the pressure chamber CV by being driven. The acquisition section 73 acquires the simultaneous drive number N_{PZ} that is the number of piezoelectric elements PZ to be simultaneously driven among the plurality of piezoelectric elements PZ. The determination section 70 determines the drive signal Com by adjusting the timing of changing the potential of the drive signal Com for driving the piezoelectric element PZ of the simultaneous drive number N_{PZ} based on the simultaneous drive number N_{PZ}. The drive signal generation circuit 2 outputs the drive signal Com determined by the determination section 70.

In addition, the first embodiment can also be defined as a drive method of a liquid ejecting apparatus including the liquid ejecting head 1, the drive signal generation circuit 2 that outputs the drive signal Com for driving one or more piezoelectric elements PZ among the plurality of piezoelectric elements PZ, and the control section 7 that controls the liquid ejecting head 1 and the drive signal generation circuit 2. Here, the control section 7 controls the DA conversion circuit 3, and the DA conversion circuit 3 controls the drive signal generation circuit 2, so that it can be said that the control section 7 controls the drive signal generation circuit 2. In the step SC102, the control section 7 acquires the simultaneous drive number N_{PZ}, and, in the step SC114, outputs the waveform designation signal dCom to cause the drive signal generation circuit 2 to output the drive signal Com in which the potential is changed at the timing adjusted based on the simultaneous drive number N_{PZ}.

As described above, the simultaneous drive number N_{PZ} and the inversion period are proportional to each other. Therefore, according to the first embodiment, a period for which the voltage supplied to the piezoelectric element PZ is unnecessarily held can be shortened as compared with an aspect in which the potential of the drive signal Com is fluctuated assuming that the inversion period is sufficiently long. Further, according to the first embodiment, the pressure chamber CV can be suppressed from being contracted before the pressure chamber CV is sufficiently expanded as compared with the aspect in which the timing of changing the potential of the drive signal Com is not adjusted, so that the characteristics of the piezoelectric element PZ can be further drawn out. That is, according to the first embodiment, the appropriate drive signal Com corresponding to the length of the inversion period can be supplied to the M piezoelectric elements PZ.

Further, the liquid ejecting apparatus 100 further includes the oscillation circuit 4 that outputs the plurality of clock signals CLK for adjusting the timing of changing the potential of the drive signal Com at a constant frequency, and the determination section 70 adjusts the potential change timing by adjusting at least one element of the drive signal Com based on the simultaneous drive number N_{PZ} and the clock signal CLK.

According to the first embodiment, the potential change timing can be adjusted in synchronization with the clock signal CLK.

The drive signal Com includes at least the first expansion element EF1 that changes the potential to expand the pressure chamber CV, the first holding element PW1 that holds the potential constant after the first expansion element EF1, the contraction element ET that changes the potential to contract the pressure chamber CV after the first holding element PW1, and the second holding element PW2 that holds the potential constant after the contraction element ET.

According to the first embodiment, the appropriate drive signal Com can be supplied to the M piezoelectric elements PZ regardless of whether the pull-push-pull waveform or the pull-push waveform is supplied to the piezoelectric element PZ.

The liquid ejecting head 1 forms an image on the medium PP by ejecting the ink to the medium PP, and the determination section 70 adjusts the potential change timing by extending the period of the first holding element PW1 by the first integer multiple of the adjustment cycle T_{CLK} when the simultaneous drive number N_{PZ} is an integer that is equal to or greater than the first threshold value and less than the second threshold value in the i-th pixel column, and by extending the period of the first holding element PW1 by the second integer multiple of the adjustment cycle T_{CLK} when the simultaneous drive number N_{PZ} is an integer that is equal to or greater than the second threshold value and equal to or less than M in the i-th pixel column.

According to the first embodiment, the appropriate drive signal Com can be supplied to the M piezoelectric elements PZ as compared with the aspect in which the length of the period of the first holding element PW1 is a fixed length. Specifically, in the liquid ejecting apparatus 100 according to the first embodiment, when the pull inversion period is shorter than the fixed length, the period for which the voltage supplied to the piezoelectric element PZ is unnecessarily held can be shortened, and when the pull inversion period is longer than the fixed length, the characteristics of the piezoelectric element PZ can be further drawn out.

The determination section 70 adjusts the potential change timing by extending the period of the second holding element PW2 by the first integer multiple of the adjustment cycle T_{CLK} when the simultaneous drive number N_{PZ} is an integer that is equal to or greater than the first threshold value and less than the second threshold value in the i-th pixel column, and by extending the period of the second holding element PW2 by the second integer multiple of the adjustment cycle T_{CLK} when the simultaneous drive number N_{PZ} is an integer that is equal to or greater than the second threshold value and equal to or less than M in the i-th pixel column.

According to the first embodiment, as compared with an aspect in which the length of the period of the second holding element PW2 is a fixed length, when the push inversion period is shorter than the fixed length, a period for which the voltage supplied to the piezoelectric element PZ is unnecessarily held can be shortened, and when the push inversion period is longer than the fixed length, the characteristics of the piezoelectric element PZ can be further drawn out.

The liquid ejecting head 1 forms an image on the medium PP by ejecting the ink to the medium PP, and the liquid ejecting apparatus 100 further includes the image signal output section 71 that outputs the image signal SI indicating whether or not the ink is ejected from the nozzle N communicating with the pressure chamber CV to which each of the plurality of piezoelectric elements PZ applies pressure for each pixel column included in the image, and the acquisition section 73 acquires the simultaneous drive number N_{PZ} for each pixel column based on the image signal SI.

As illustrated in FIG. 20, the simultaneous drive number N_{PZ} may fluctuate according to the pixel column included in the image. According to the first embodiment, the appropriate drive signal Com can be supplied to the M piezoelectric elements PZ according to the simultaneous drive number N_{PZ} for each pixel column.

### B. Second Embodiment

As understood from the inversion period characteristic te_Pull and the inversion period characteristic te_Push of FIG. 12, the pull inversion period is longer than the push inversion period even with the same simultaneous drive number N_{PZ}. Therefore, in the second embodiment, the pull extension period is set to be longer than the push extension period. Hereinafter, the second embodiment will be described.

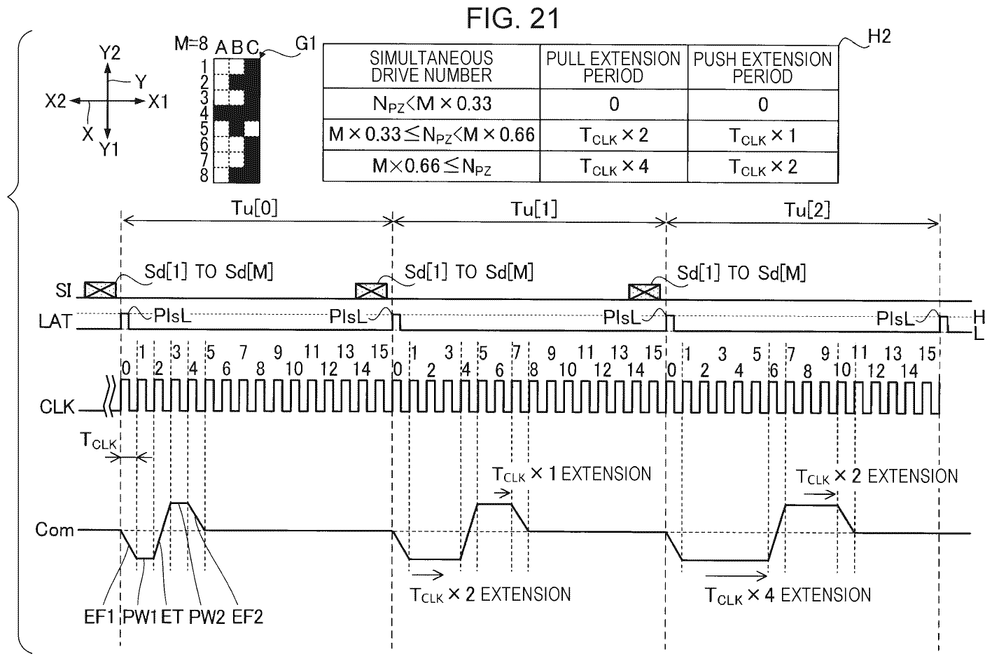

FIG. 21 is a diagram for describing a specific example of the process of the step SC112 in the second embodiment. Table H2 illustrated in FIG. 21 illustrates an example of the relationship between the simultaneous drive number N_{PZ} and the extension period. As illustrated in Table H2, the control section 7 sets the extension period to 0 when the simultaneous drive number N_{PZ} is less than M×0.33. Further, as illustrated in Table H2, when the simultaneous drive number N_{PZ} is equal to or greater than M×0.33 and less than M×0.66, the control section 7 sets the pull extension period to the two adjustment cycles T_{CLK} and sets the push extension period to the one adjustment cycle T_{CLK}. Further, as illustrated in Table H2, when the simultaneous drive number N_{PZ} is equal to or greater than M×0.66, the control section 7 sets the pull extension period to the four adjustment cycles T_{CLK} and sets the push extension period to the two adjustment cycles T_{CLK}.

In the second embodiment, when the simultaneous drive number N_{PZ} is equal to or greater than M×0.33 and less than M×0.66, the two adjustment cycles T_{CLK} set as the pull extension period is an example of the “first period”. When the simultaneous drive number N_{PZ} is equal to or greater than M×0.33 and less than M×0.66, the one adjustment cycle T_{CLK} set as the push extension period is an example of the “third period”. That is, in the second embodiment, the “first period” is longer than the “third period”. Similarly, when the simultaneous drive number N_{PZ} is equal to or greater than M×0.66, the four adjustment cycles T_{CLK} set as the pull extension period is an example of the “second period”. When the simultaneous drive number N_{PZ} is equal to or greater than M×0.66, the two adjustment cycles T_{CLK} set as the push extension period is an example of the “fourth period”. That is, in the second embodiment, the “second period” is longer than the “fourth period”. In the second embodiment, the “first period” and the “fourth period” are equal to each other, but may be different.

Since the unit period Tu[0] is the same as that in FIG. 20, the description thereof will be omitted. In the unit period Tu[1], the simultaneous drive number N_{PZ} is equal to or greater than M×0.33 and less than M×0.66. The control section 7 sets the time of the termination included in the termination information of the first holding element PW1 and the termination information of the contraction element ET, to be delayed by the two adjustment cycles T_{CLK}. As in the first embodiment, the time of the termination of the element after the second holding element PW2 is required to add the pull extension period, which is the extension period of the first holding element PW1, in addition to the push extension period, which is the extension period of the second holding element PW2. Therefore, the control section 7 sets the time of the termination included in the termination information of the second holding element PW2 and the termination information of the second expansion element EF2 of the waveform information CL, to be delayed by the three adjustment cycles T_{CLK}.

In the unit period Tu[2], the simultaneous drive number N_{PZ} is equal to or greater than M×0.66. The control section 7 sets the time of the termination included in the termination information of the first holding element PW1 and the termination information of the contraction element ET, to be delayed by the four adjustment cycles T_{CLK}, and sets the time of the termination included in the termination information of the second holding element PW2 and the termination information of the second expansion element EF2 of the waveform information CI, to be delayed by the six adjustment cycles T_{CLK}.

As described above, according to the second embodiment, the first period is longer than the third period, and the second period is longer than the fourth period. In other words, the pull extension period is longer than the push extension period.

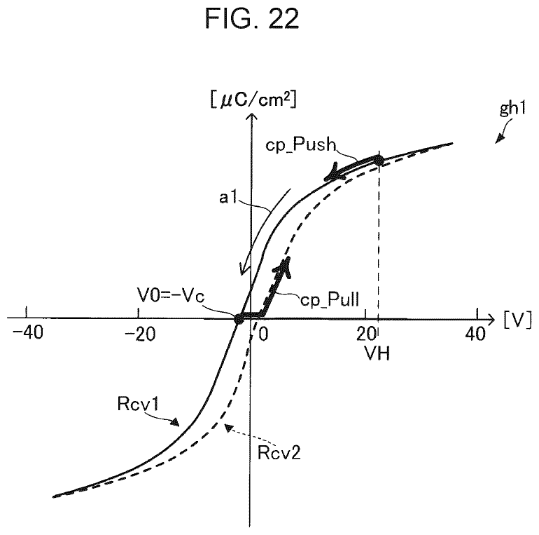

According to the second embodiment, although the same simultaneous drive number N_{PZ} is used, the pull inversion period is longer than the push inversion period, so that, by setting the pull extension period to be longer than the push extension period, the appropriate drive signal Com can be supplied to the M piezoelectric elements PZ as compared with the first embodiment. The reason why the pull inversion period is longer than the push inversion period will be described with reference to FIG. 22.

FIG. 22 is a diagram illustrating a hysteresis curve indicating a relationship between the voltage and the polarization of the piezoelectric body Zm. The horizontal axis of a graph gh1 illustrated in FIG. 22 is the voltage [V], and the vertical axis is the polarization [μC/cm²]. In order to increase the ejection amount, it is preferable to change the voltage from a counter voltage −Vc to a saturation positive voltage. During the period of the first expansion element EF1, in other words, during the period in which the reference voltage V0 changes to the lowest voltage VL, the voltage decreases toward the counter voltage −Vc, which is the reference voltage V0 in the counter electric field along a route Rcv1 of the hysteresis curve illustrated in FIG. 22, and the polarization changes to the negative side. That is, it changes as indicated by an arrow al.

During the period of the contraction element ET, in other words, during the period of changing from the lowest voltage VL to the highest voltage VH, a route Rcv1 of the graph gh1 is changed to a route Rcv2, and the polarization is changed to the positive side by the potential difference ΔVh.

The Cᵤₙᵢₜ of Expression (6) increases as the inclination of the graph gh1 becomes steep. During the pull inversion period, the polarization changes along a curve cp_Pull in the graph gh1, and during the push inversion period, the polarization changes along a curve cp_Push in the graph gh1. As understood from FIG. 22, the inclination of the curve cp_Pull is steeper than the inclination of the curve cp_Push. Therefore, from Expression (6), although the simultaneous drive number N_{PZ} is the same, the pull extension period is longer than the push extension period.

Since the pull extension period and the push extension period are the same, the liquid ejecting apparatus 100 in the first embodiment can reduce the processing load of the control section 7 as compared with the liquid ejecting apparatus 100 in the second embodiment.

### C. Modification Example

Each of the above-exemplified forms can be variously modified. Specific modification aspects that can be applied to each of the above-described forms will be described below. Two or more aspects optionally selected from the following examples can be appropriately merged to the extent that they do not contradict each other.

### C1. First Modification Example

In the step SC112 of each of the aspects described above, the control section 7 may adjust the waveform information CI such that the period of the first holding element PW1 is extended according to the increase in the simultaneous drive number N_{PZ}, and may not adjust the period of the second holding element PW2. Alternatively, in the step SC112, the control section 7 may adjust the waveform information CI such that the period of the second holding element PW2 is extended according to the increase in the simultaneous drive number N_{PZ}, and may not adjust the period of the first holding element PW1.

### C2. Second Modification Example

In each of the aspects described above, in order to correspond to the reset inversion period, the control section 7 may adjust the waveform information CI such that the period of the end potential holding element ae is extended according to the increase in the simultaneous drive number N_{PZ}. Further, the control section 7 may adjust the waveform information CI such that the period of the end potential holding element ae is extended according to the increase in the simultaneous drive number N_{PZ}, and may not adjust the period of the first holding element PW1 and the period of the second holding element PW2.

### C3. Third Modification Example

In each of the aspects described above, a serial type liquid ejecting apparatus that reciprocates the storage case 921 accommodating the liquid ejecting head 1 is exemplified, but the present disclosure can also be applied to a line type liquid ejecting apparatus in which a plurality of nozzles N are distributed over the entire width of the medium PP. In the third modification example, when the nozzle column Ln is in a direction intersecting the Y-axis, for example, in a direction along the X-axis, the pixel column of the pixels formed at the medium PP is a set of M pixels in the direction along the X-axis.

### C4. Fourth Modification Example

The liquid ejecting apparatus 100 described in each of the aspects described above as an example can be adopted not only for an apparatus dedicated to printing but also for various apparatus such as a facsimile device and a copying machine. Note that the application of the liquid ejecting apparatus is not limited to printing. For example, a liquid ejecting apparatus that ejects a solution of a coloring material is used as a manufacturing device that forms a color filter of a display device such as a liquid crystal display panel. In addition, a liquid ejecting apparatus that ejects a solution of a conductive material is used as a manufacturing device that forms wiring or an electrode of a wiring substrate. In addition, a liquid ejecting apparatus that ejects a solution of an organic substance related to a living body is used as a manufacturing device that manufactures a biochip, for example.

What is claimed is:

1. A liquid ejecting apparatus comprising:
a liquid ejecting head that is provided with a plurality of piezoelectric elements that apply pressure to a liquid in a pressure chamber by being driven;
an acquisition section that acquires a simultaneous drive number, which is the number of piezoelectric elements simultaneously driven among the plurality of piezoelectric elements;
a determination section that determines a drive signal for driving the piezoelectric elements of the simultaneous drive number by adjusting a timing of changing a potential of the drive signal based on the simultaneous drive number; and
a drive signal output section that outputs the drive signal determined by the determination section.

2. The liquid ejecting apparatus according to claim 1, further comprising:
an adjustment signal output section that outputs a plurality of adjustment signals for adjusting the timing at a constant frequency, wherein
the determination section determines the drive signal by adjusting at least one element of the drive signal based on the simultaneous drive number and the adjustment signals.

3. The liquid ejecting apparatus according to claim 2, wherein
the drive signal includes at least an expansion element that changes the potential to expand the pressure chamber, a first holding element that holds the potential constant after the expansion element, a contraction element that changes the potential to contract the pressure chamber after the first holding element, and a second holding element that holds the potential constant after the contraction element.

4. The liquid ejecting apparatus according to claim 3, wherein
the liquid ejecting head forms an image on a medium by ejecting a liquid to the medium, and
the determination section adjusts the timing by extending a period of the first holding element by a first period when the simultaneous drive number is a first number in a first pixel column of the image, and by extending the period of the first holding element by a second period longer than the first period when the simultaneous drive number is a second number larger than the first number in the first pixel column.

5. The liquid ejecting apparatus according to claim 4, wherein
the determination section adjusts the timing by extending a period of the second holding element by a third period when the simultaneous drive number is the first number in the first pixel column, and by extending the period of the second holding element by a fourth period longer than the third period when the simultaneous drive number is the second number in the first pixel column.

6. The liquid ejecting apparatus according to claim 5, wherein
the first period is equal to the third period, and
the second period is equal to the fourth period.

7. The liquid ejecting apparatus according to claim 5, wherein
the first period is longer than the third period, and
the second period is longer than the fourth period.

8. The liquid ejecting apparatus according to claim 3, wherein
the liquid ejecting head forms an image on a medium by ejecting a liquid to the medium, and
the determination section adjusts the timing by extending a period of the second holding element by a third period when the simultaneous drive number is a first number in a first pixel column of the image, and by extending the period of the second holding element by a fourth period longer than the third period when the simultaneous drive number is a second number larger than the first number in the first pixel column.

9. The liquid ejecting apparatus according to claim 1, wherein
the liquid ejecting head forms an image on a medium by ejecting a liquid to the medium,
the liquid ejecting apparatus further comprises an image signal output section that outputs an image signal indicating whether or not to eject the liquid from a nozzle communicating with the pressure chamber to which each of the plurality of piezoelectric elements applies the pressure, for each pixel column included in the image, and
the acquisition section acquires the simultaneous drive number for each pixel column based on the image signal.

10. A drive method of a liquid ejecting apparatus including
a liquid ejecting head provided with a plurality of piezoelectric elements that apply pressure to a liquid in a pressure chamber by being driven,
a drive signal output section that outputs a drive signal for driving one or more piezoelectric elements among the plurality of piezoelectric elements, and
a control section that controls the liquid ejecting head and the drive signal output section, the method comprising:
causing the control section
to acquire a simultaneous drive number, which is the number of piezoelectric elements simultaneously driven among the plurality of piezoelectric elements, and
to cause the drive signal output section to output the drive signal in which a potential is changed at a timing adjusted based on the simultaneous drive number.
